(19) United States
(12) Patent Application Publication
(10) Pub. No.: US 2004/0117319 A1
(43) Pub. Date: Jun. 17, 2004

(54) Used article quotation method and system

(76) Inventors: Yasuhiro Oshima, Nagano-ken (JP); Takao Sekizawa, Nagano-ken (JP); Yasuo Shibusawa, Nagano-ken (JP); Yoshiyuki Aido, Nagano-ken (JP)

Correspondence Address: MARTINE & PENILLA, LLP, 710 LAKEWAY DRIVE, SUITE 170, SUNNYVALE, CA, 94085, US

(21) Appl. No.: 10/674,988

(22) Filed: Sep. 29, 2003

(30) Foreign Application Priority Data
Sep. 30, 2002 (JP) 2002-286000
Sep. 30, 2002 (JP) 2002-286001
Sep. 30, 2002 (JP) 2002-286002

(51) Int. Cl. H04K 1/00

(52) U.S. Cl. 705/75

(57) ABSTRACT

A Web server receives a maximum cash-out quote PAmax of a used article from a database server and calculates a minimum cash-out quote PAmin, a maximum trade-in quote PBmax, and a minimum trade-in quote PBmin of the used article from the maximum cash-out quote PAmax (step S210). The maximum cash-out quote PAmax is compared with a preset threshold value P1 (step S220). When the maximum cash-out quote PAmax exceeds the preset threshold value P1, it is determined that the used article is worth of both a cash-out without purchase of any new product and a trade-in with purchase of anew product. The Web server accordingly creates a quotation window including the maximum cash-out quote PAmax, the minimum cash-out quote PAmin, the maximum trade-in quote PBmax, and the minimum trade-in quote PBmin of the used article (step S230) and sends the quotation window thus created to a user computer.

### BACKGROUND OF THE INVENTION

1. Field of the Invention

The present invention relates to a used article quotation method and a corresponding system that provides a user computer with a quote for acceptance of a used article from a user.

Further, the present invention relates to a used article quotation method and corresponding system that is utilized for a trade-in of a used article from a user.

2. Description of the Prior Art

Several systems have been proposed to provide a user with a quote for acceptance of a used article from a user. For example, a recycle support system via a computer network is disclosed in Patent Laid-Open Gazette No. 2002-215771. When the user specifies a used article on a quotation input window and activates a quotation button to gain a quote, a server computer computes a quote of the used article and sends the computed quote to a user computer. Dell PC Trade-Up Service (online service by Dell Computer Corporation [retrieved on Sep. 27, 2002], Internet <URL: http://www.dell.com/jp/jp/dhs/topics/nnsegtopic_kaitori.htm>) gives computer trade-in service subjected to users who intend to purchase new products. When the user enters information regarding the specification of a used computer owned by the user, such as the specifications of the CPU, the memory, and the HDD, on an information input window and gives a quotation request, the server computer provides the user with a trade-in quote of the used computer.

There are mainly two cases when the user requires the trader to accept a used article. In one case, the user intends to purchase a new product and accordingly does not require a used article. In the other case, the user does not intend to purchase any new product but does not require a used article. In the specification hereof, the acceptance of the used article in the former case is referred to as ‘trade-in’, whereas the acceptance of the used article in the latter case is referred to as ‘cash-out’ While there are two trades with regard to acceptance of the used article, that is, trade-in and cash-out, the above cited reference takes into account only either of the trade-in or the cash-out and does not give any indication that allows the user to select either a trade-in or a cash-out. The trader that accepts the used article is naturally expected to take advantage of the chance of accepting the used article from the user and motivate the user to purchase products.

The computer trade-in service ‘Dell PC Trade-Up Service’ makes an assessment and transfers a trade-in price based on the assessment to the user when the trade-in quote is not less than a specified value. When the trade-in quote is less than the specified value, on the other hand, the computer trade-in service does not make an assessment and uniformly delivers a fixed price of discount coupon to the user. Used computers having the trade-in quote of less than the specified value often have different actual values. For example, the actual value of a used computer having a trade-in quote very close to the specified value is distinctly different from the actual value of a used computer having a trade-in quote very close to zero. Giving the fixed price to these used computers having different actual values may lower the user's satisfaction level.

In the computer trade-in service ‘Dell PC Trade-Up Service’, the system is not designed to allow for exchange of information between a product purchase procedure and a trade-in procedure of the used article. Even when some pieces of information to be entered for the former procedure overlap with pieces of information to be entered for the latter procedure, the user is required to enter the overlapping pieces of information twice for both of the procedures. Such entries undesirably consume the time and the labor of the user.

### SUMMARY OF THE INVENTION

The object of the present invention is thus to provide a used article quotation method that provides a user with an indication that allows the user to select either a trade-in or a cash-out of a used article, as well as a corresponding used article quotation system. The object of the invention is also to provide a used article quotation method that takes advantage of a chance of accepting a used article from the user and thereby motivates the user to purchase products, as well as a corresponding used article quotation system.

In order to achieve the above object, a used article quotation method of the present invention is a method that provides a user computer with a quote for acceptance of a used article from a user, the used article quotation method including the steps of: (a) causing a server computer, which is connected with the user computer in a communicable manner, to receive a quotation request of the used article and quotation requirement information, which is required for quotation of the used article, from the user computer and to determine a trade-in quote for the acceptance of the used article that is a trade-in of the used article with purchase of a product and a cash-out quote for the acceptance of the used article that is a cash-out of the used article without purchase of a product, based on the quotation requirement information; and (b) causing the server computer to send quotation information, which includes the trade-in quote and the cash-out quote determined in the step (a), to the user computer.

The used article quotation method of the invention receives a quotation request of a used article and quotation requirement information, which is required for quotation of the used article, from the user computer, determines a trade-in quote and a cash-out quote of the used article based on the quotation requirement information, and sends the trade-in quote and the cash-out quote thus determined to the user computer. This arrangement gives the user the comparison between the trade-in quote and the cash-out quote, that is, the indication to allow the user to select either a trade-in or a cash-out of the used article. The server computer may include only a single computer or multiple computers.

The terminology ‘used article’ in the specification hereof represents articles that are not brand new and include articles that have not been used but have become old with elapse of time, as well as articles that have been used for some time. In the step (a), the server computer may receive the quotation requirement information simultaneously with the quotation request of the used article or may separately receive the quotation request of the used article and the quotation requirement information.

In the used article quotation method of the invention, the step (a) may cause the server computer to determine the trade-in quote and the cash-out quote in such a manner that the trade-in quote is advantageous over the cash-out quote.

In the used article quotation method of the invention, the step (a) may further cause the server computer either to determine first the cash-out quote and then the trade-in quote based on the predetermined cash-out quote in such a manner that the trade-in quote is advantageous over the cash-out quote, or to determine first the trade-in quote and then the cash-out quote based on the predetermined trade-in quote in such a manner that the trade-in quote is advantageous over the cash-out quote. More specifically, the step (a) may cause the server computer either to determine the cash-out quote and compute the trade-in quote as a function of the predetermined cash-out quote, or to determine the trade-in quote and compute the cash-out quote as a function of the predetermined trade-in quote.

In the used article quotation method of the invention, the step (a) may still further cause the server computer to set a minimum value and a maximum value of the cash-out quote and a maximum value and a minimum value of the trade-in quote.

In the used article quotation method of the invention, the step (b) may cause the server computer to transmit a quotation window, which includes a cash-out option selected by the user to request a cash-out at the cash-out quote and a trade-in option selected by the user to request a trade-in at the trade-in quote, in addition to the cash-out quote and the trade-in quote, as the quotation information to the user computer. For example, in response to the user's selection of the cash-out option, the server computer may require the user to send information required for the cash-out of the used article. In response to the user's selection of the trade-in option, on the other hand, the server computer may provide the user computer with a product purchase site. The used article quotation method of the invention may further include the steps of: (c) in response to receipt of the user's selection of the trade-in option from the user computer after the step (b), causing the server computer to store a trade-in specification, which includes the quotation requirement information and the trade-in quote, into a storage unit; and (d) in response to receipt of a product purchase request from the user computer, causing the server computer to read the trade-in specification stored in the storage unit, to send the read-out trade-in specification to the user computer, and to ask the user whether to effectuate a trade-in according to the trade-in specification.

In the used article quotation method of the invention, the step (b) may cause the server computer to determine whether the cash-out quote, which has been determined based on the quotation requirement information, is in a preset allowable cash-out value range and, when it is determined that the cash-out quote is out of the preset allowable cash-out value range, to send the quotation information excluding the cash-out quote to the user computer.

In the used article quotation method of the invention, the step (b) may further cause the server computer to send a quotation window, which includes a cash-out option selected by the user to request a cash-out at the cash-out quote and a trade-in option selected by the user to request a trade-in at the trade-in quote, in addition to the cash-out quote and the trade-in quote, as the quotation information to the user computer and, when the cash-out quote, which has been determined based on the quotation requirement information, is out of a preset allowable cash-out value range, to send either of the quotation window excluding the cash-out option or the quotation window including the cash-out option in a certain state that does not allow for the user's selection, to the user computer.

In the used article quotation method of the invention, the step (a) may cause the server computer to receive the quotation request of the used article and information regarding a component included in the used article as the quotation requirement information, which is required for quotation of the used article, from the user computer and to determine the trade-in quote and the cash-out quote, based on the information regarding the component included in the used article.

A used article quotation system of the present invention is a system that provides a user computer with a quote for acceptance of a used article from a user, the used article quotation system including:

a quote determination module that receives a quotation request of the used article and quotation requirement information, which is required for quotation of the used article, from the user computer and determines a trade-in quote for the acceptance of the used article that is a trade-in of the used article with purchase of a product and a cash-out quote for the acceptance of the used article that is a cash-out of the used article without purchase of a product, based on the quotation requirement information; and

a quotation information transmission module that sends quotation information, which includes the trade-in quote and the cash-out quote determined by the quote determination module, to the user computer.

The used article quotation system of the invention receives a quotation request of a used article and quotation requirement information, which is required for quotation of the used article, from the user computer, determines a trade-in quote and a cash-out quote of the used article based on the quotation requirement information, and sends the trade-in quote and the cash-out quote thus determined to the user computer. This arrangement gives the user the comparison between the trade-in quote and the cash-out quote, that is, the indication to allow the user to select either a trade-in or a cash-out of the used article.

The used article quotation method of the invention may be actualized in the form of a used article quotation program. The present invention is accordingly directed to a used article quotation program that is executed to provide a user computer with a quote for acceptance of a used article from a user. The used article quotation program causes a server computer, which is connected with the user computer in a communicable manner, to attain the functions of: (a) receiving a quotation request of the used article and quotation requirement information, which is required for quotation of the used article, from the user computer and determining a trade-in quote for the acceptance of the used article that is a trade-in of the used article with purchase of a product and a cash-out quote for the acceptance of the used article that is a cash-out of the used article without purchase of a product, based on the quotation requirement information; and (b) sending quotation information, which includes the trade-in quote and the cash-out quote determined by the function (a), to the user computer.

The used article quotation program may be provided in any suitable form, for example, may be recorded in a computer readable recording medium (for example, a hard disk, a ROM, an FD, a CD, or a DVD) or distributed from one computer to another computer via a transmission medium (a communication network like the Internet or a LAN). The used article quotation program, executed by a server computer, receives a quotation request of a used article and quotation requirement information, which is required for quotation of the used article, from the user computer, determines a trade-in quote and a cash-out quote of the used article based on the quotation requirement information, and sends the trade-in quote and the cash-out quote thus determined to the user computer. This arrangement gives the user the comparison between the trade-in quote and the cash-out quote, that is, the indication to allow the user to select either a trade-in or a cash-out of the used article. The server computer may include only a single computer or multiple computers.

The object of the invention is also to provide a used article quotation method that heightens the user's satisfaction level, even when a used article is accepted from the user at a fixed firm price without assessment, as well as a corresponding used article quotation system.

To achieve the above object, a used article quotation method of the present invention is a method that provides a user computer with a quote for acceptance of a used article from a user, the used article quotation method including the steps of: (a) causing a server computer, which is connected with the user computer in a communicable manner, to receive a quotation request of the used article and quotation requirement information, which is required for quotation of the used article, from the user computer and to set a tentative quote of the used article, based on the quotation requirement information; (b) causing the server computer to determine whether assessment of the used article is required, according to the tentative quote; (c) when it is determined in the step (b) that assessment of the used article is not required, causing the server computer to determine a settled price of no value range according to the tentative quote as a firm price for acceptance of the used article without assessment and to set the firm price to a final quote of the used article; and (d) causing the server computer to send quotation information including the final quote, to the user computer.

The used article quotation method of the invention receives a quotation request of a used article and quotation requirement information, which is required for quotation of the used article, from the user computer, sets a tentative quote of the used article, based on the quotation requirement information, and determines whether assessment of the used article is required, according to the tentative quote. When it is determined that assessment of the used article is not required, the used article quotation method determines a settled price of no value range according to the tentative quote as a firm price for acceptance of the used article without assessment, sets the firm price to a final quote of the used article, and sends quotation information including the final quote, to the user computer. Even when the used article is accepted at the fixed firm price without assessment, the firm price is settled according to the tentative quote, that is, according to the value of the used article. This arrangement desirably heightens the user's satisfaction level. In the server computer of the invention, only one computer may execute all the procedures or multiple computers may share execution of the procedures.

In the used article quotation method of the invention, the step (b) may cause the server computer to determine that assessment of the used article is not required, when the tentative quote is less than a preset assessment requirement judgment value.

In the used article quotation method of the invention, the step (c), when it is determined in the step (b) that assessment of the used article is not required, may cause the server computer to specify a value level of the tentative quote and to set either of the settled price of no value range determined according to the tentative quote or a fixed value regardless of the tentative quote to the firm price, based on the specified value level.

In the used article quotation method of the invention, the step (c), when it is determined in the step (b) that assessment of the used article is not required, may further cause the server computer to compare the tentative quote with a predetermined value level criterion and to set the settled price of no value range determined according to the tentative quote to the firm price in the case where the tentative quote exceeds the predetermined value level criterion and to set a fixed value regardless of the tentative quote to the firm price in the case where the tentative quote is not greater than the predetermined value level criterion.

In the used article quotation method of the invention, the step (c), when it is determined in the step (b) that assessment of the used article is required, may still further cause the server computer to set a value range according to the tentative quote to the final quote of the used article on the condition of assessment of the used article.

The used article quotation method of the invention may further include the step of: (e) causing the server computer to determine whether the used article is worth of acceptance, based on the setting of the tentative quote in the step (a), and when it is determined in the step (e) that the used article is not worth of acceptance, the step (d) may cause the server computer to send the quotation information including a notice that the used article is not acceptable, to the user computer.

In the used article quotation method of the invention: the step (a) may cause the server computer to receive the quotation request of the used article and the quotation requirement information, which is required for quotation of the used article, from the user computer and to set a tentative trade-in quote for the acceptance of the used article that is a trade-in with purchase of a product and a tentative cash-out quote for the acceptance of the used article that is a cash-out without purchase of a product, based on the quotation requirement information; the step (b) may cause the server computer to determine whether assessment of the used article is required individually with regard to the trade-in and the cash-out, and when it is determined in the step (b) that assessment of the used article is not required with regard to each of the trade-in and the cash-out; the step (c) may cause the server computer to determine a settled trade-in price of no value range according to the tentative trade-in quote as a firm trade-in price for the trade-in without assessment and set the firm trade-in price to a final trade-in quote of the used article, and to determine a settled cash-out price of no value range according to the tentative cash-out quote as a firm cash-out price for the cash-out without assessment and set the firm cash-out price to a final cash-out quote of the used article; and the step (d) may cause the server computer to send the quotation information including both the final trade-in quote and the final cash-out quote, to the user computer. In this case, the used article quotation method of the invention may further include the step of: (f) causing the server computer to determine whether the used article is worth of acceptance with regard to at least the cash-out, based on the setting of the tentative cash-out quote in the step (a), and when it is determined in the step (f) that the used article is not worth of acceptance, the step (d) may cause the server computer to send the quotation information including a notice that the used article is not acceptable, to the user computer. In a similar manner, trade-in of any worthless used articles may be rejected. The trade-in of each used article is, however, on the condition of purchase of a new product. The system often makes profits through sales of new products even with trade-in of worthless used articles. As long as the profits are ensured, the system may accept the trade-in of even the worthless used articles.

A used article quotation system of the present invention is a system that provides a user computer with a quote for acceptance of a used article from a user, the used article quotation system including: a tentative quote setting module that receives a quotation request of the used article and quotation requirement information, which is required for quotation of the used article, from the user computer and sets a tentative quote of the used article based on the quotation requirement information; an assessment requirement judgment module that determines whether assessment of the used article is required, according to the tentative quote set by the tentative quote setting module; a final quote setting module that, when it is determined that assessment of the used article is not required by the assessment requirement judgment module, determines a settled price of no value range according to the tentative quote as a firm price for acceptance of the used article without assessment and sets the firm price to a final quote of the used article; and a quotation information transmission module that sends quotation information including the final quote set by the final quote setting module, to the user computer.

The used article quotation system of the invention receives a quotation request of a used article and quotation requirement information, which is required for quotation of the used article, from the user computer, sets a tentative quote of the used article, based on the quotation requirement information, and determines whether assessment of the used article is required, according to the tentative quote. When it is determined that assessment of the used article is not required, the used article quotation system determines a settled price of no value range according to the tentative quote as a firm price for acceptance of the used article without assessment, sets the firm price to a final quote of the used article, and sends quotation information including the final quote, to the user computer. Even when the used article is accepted at the fixed firm price without assessment, the firm price is settled according to the tentative quote, that is, according to the value of the used article. This arrangement desirably heightens the user's satisfaction level. The tentative quote setting module may receive the quotation requirement information simultaneously with the quotation request of the used article or may separately receive the quotation request of the used article and the quotation requirement information.

The used article quotation method of the invention may be actualized in the form of a used article quotation program. The present invention is accordingly directed to a used article quotation program that is executed to provide a user computer with a quote for acceptance of a used article from a user. The used article quotation program causes a server computer, which is connected with the user computer in a communicable manner, to attain the functions of: (a) receiving a quotation request of the used article and quotation requirement information, which is required for quotation of the used article, from the user computer setting a tentative quote of the used article, based on the quotation requirement information; (b) determining whether assessment of the used article is required, according to the tentative quote; (c) when it is determined in the step (b) that assessment of the used article is not required, determining a settled price of no value range according to the tentative quote as a firm price for acceptance of the used article without assessment and setting the firm price to a final quote of the used article; and (d) sending quotation information including the final quote, to the user computer.

The used article quotation program may be recorded in a computer readable recording medium (for example, a hard disk, a ROM, an FD, a CD, or a DVD), may be transferred from one computer to another computer via a transfer medium (a communication network like the Internet or a LAN), or may be transmitted in any other suitable form. The server computer executes this program to attain the used article quotation method discussed above and thereby exerts the similar functions and effects to those of the used article quotation method discussed above. In the server computer of the invention, only one computer may execute all the procedures or multiple computers may share execution of the procedures.

The object of the invention is further to provide a server management method that does not require the user to enter identical pieces of information many times for trade-in of a used article, as well as a corresponding used article quotation method and a corresponding used article quotation system.

To achieve the above object, a server management method for managing a server of the present invention, which is connected with a user computer in a communicable manner and opens a used article quotation site that is utilized by a user to ask for acceptance of a used article and a shopping site that is utilized by the user to purchase a product, includes the step of: when a server computer receives information regarding a product purchase procedure at the shopping site from the user computer after receipt of information regarding a trade-in quotation request of the used article at the used article quotation site from the user computer, causing the server computer to go through a trade-in procedure without requiring the user computer to reenter the information regarding the trade-in quotation request of the used article; or when a server computer requires the user computer to enter information regarding a trade-in quotation request of the used article at the used article quotation site after receipt of information regarding a product purchase procedure at the shopping site from the user computer, causing the server computer not to require the user computer to reenter a piece of information overlapping with the information regarding the product purchase procedure, among pieces of the information regarding the trade-in quotation request of the used article.

The server computer may receive the information regarding the trade-in quotation request of the used article at the used article quotation site from the user computer, prior to receipt of the information regarding the product purchase procedure at the shopping site from the user computer. In such cases, the server management method of the invention goes through a trade-in procedure without requiring the user computer to reenter the information regarding the trade-in quotation request of the used article, after receipt of the information regarding the product purchase procedure at the shopping site. When the server computer requires the user computer to enter the information regarding the trade-in quotation request of the user article at the used article quotation site after receipt of the information regarding the product purchase procedure at the shopping site from the user computer, the server management method does not require the user computer to reenter a piece of information overlapping with the information regarding the product purchase procedure, among pieces of the information regarding the trade-in quotation request of the used article. Either of these arrangements does not require the user to enter identical pieces of information many times for a trade-in of the used article and thereby effectively saves the time and the labor of the user. In the server computer of the invention, only one computer may execute all the procedures or multiple computers may share execution of the procedures.

A used article quotation method of the present invention is a method that is utilized for a trade-in of a used article from a user, the used article quotation method including the steps of: (a) causing a server computer, which is connected with the user computer in a communicable manner, to receive information regarding a trade-in quotation request of the used article from a user computer, to determine a trade-in quote of the used article based on the information regarding the trade-in quotation request, and to send quotation information including the trade-in quote of the used article, to the user computer; (b) causing the server computer to send to the user computer either of the information regarding the trade-in quotation request of the used article or the trade-in quote of the used article in a specific format that allows for storage in the user computer; and (c) in the case where either of the information regarding the trade-in quotation request of the used article or the trade-in quote of the used article has been stored in the user computer, causing the server computer to make a trade-in procedure of the used article without requiring the user computer to reenter the information regarding the trade-in quotation request of the used article, after the user completes a product purchase procedure.

The used article quotation method of the invention receives information regarding a trade-in quotation request of the used article from a user computer, determines a trade-in quote of the used article based on the information regarding the trade-in quotation request, and sends quotation information including the trade-in quote of the used article, to the user computer. The used article quotation method then sends to the user computer either of the information regarding the trade-in quotation request of the used article or the trade-in quote of the used article in a specific format that allows for storage in the user computer. In the case where either of the information regarding the trade-in quotation request of the used article or the trade-in quote of the used article has been stored in the user computer, the used article quotation method makes a trade-in procedure of the used article without requiring the user computer to reenter the information regarding the trade-in quotation request of the used article, after the user completes a product purchase procedure. This arrangements does not require the user to enter identical pieces of information many times for a trade-in of the used article and thereby effectively saves the time and the labor of the user. In the server computer of the invention, only one computer may execute all the procedures or multiple computers may share execution of the procedures.

In the used article quotation method of the invention, the step (b) may send to the user computer at least either of the information regarding the trade-in quotation request of the used article or the trade-in quote of the used article in a specific format that allows for storage in the user computer. In the case where the information regarding the trade-in quotation request of the used article has been stored in the user computer, the step (c) may re-determine the trade-in quote of the used article, based on the stored information. The terminology ‘trade-in of the used article’ means that the system accepts the used article upon the condition that the user newly purchases a product. The terminology ‘information regarding the product charge procedure’ includes, for example, information for specifying the user's desired products to be purchased, the postal address and the name of the user who purchases products, and the delivery address of purchased products. The terminology ‘information regarding the trade-in quotation request of the used article’ includes information required for determination of the trade-in quote of the used article, for example, the trade name of the used article and the names of the components included in the used article, the postal address and the name of the user who requests a trade-in, and the pickup address of the used article.

In the used article quotation method of the invention, the step (b) may cause the server computer to send to the user computer either of the information regarding the trade-in quotation request of the used article or the trade-in quote of the used article as a cookie that is storable in the user computer.

In the used article quotation method of the invention, step (b) may further cause the server computer to store either of the information regarding the trade-in quotation request of the used article or the trade-in quote of the used article into a predetermined storage unit, instead of sending to the user computer either of the information regarding the trade-in quotation request of the used article or the trade-in quote of the used article in the specific format that allows for storage in the user computer, and

in the case where either of the information regarding the trade-in quotation request of the used article or the trade-in quote of the used article has been stored in the predetermined storage unit, the step (c) may cause the server computer to make the trade-in procedure of the used article without requiring the user computer to reenter the information regarding the trade-in quotation request of the used article, after the user completes the product purchase procedure.

In the used article quotation method of the invention, the step (a) may cause the server computer to receive information regarding a component included in the used article as the information regarding the trade-in quotation request from the user computer and to determine the trade-in quote, based on the information regarding the component included in the used article.

In the used article quotation method of the invention, the step (a) may cause the server computer to set a minimum value and a maximum value of the trade-in quote of the used article.

A server system of the present invention is a system that is connected with a user computer in a communicable manner and opens a used article quotation site that is utilized by a user to ask for acceptance of a used article and a shopping site that is utilized by the user to purchase a product: when receiving information regarding a product purchase procedure at the shopping site from the user computer after receipt of information regarding a trade-in quotation request of the used article at the used article quotation site from the user computer, the server system going through a trade-in procedure without requiring the user computer to reenter the information regarding the trade-in quotation request of the used article; or when requiring the user computer to enter information regarding a trade-in quotation request of the user article at the used-article quotation site after receipt of information regarding a product purchase procedure at the shopping site from the user computer, the server system not requiring the user computer to reenter a piece of information overlapping with the information regarding the product purchase procedure, among pieces of the information regarding the trade-in quotation request.

The server system may receive the information regarding the trade-in quotation request of the used article at the used article quotation site from the user computer, prior to receipt of the information regarding the product purchase procedure at the shopping site from the user computer. In such cases, the server system of the invention goes through a trade-in procedure without requiring the user computer to reenter the information regarding the trade-in quotation request of the used article, after receipt of the information regarding the product purchase procedure at the shopping site. When the server computer requires the user computer to enter the information regarding the trade-in quotation request of the user article at the used article quotation site after receipt of the information regarding the product purchase procedure at the shopping site from the user computer, the server system does not require the user computer to reenter a piece of information overlapping with the information regarding the product purchase procedure, among pieces of the information regarding the trade-in quotation request of the used article. This arrangements does not require the user to enter identical pieces of information many times for a trade-in of the used article and thereby effectively saves the time and the labor of the user.

A used article quotation system of the present invention is a system that is connected with a user computer in a communicable manner and utilized by a user to ask for acceptance of a used article, the used article quotation system including:

a quotation information transmission module that receives information regarding a trade-in quotation request of the used article from the user computer, determines a trade-in quote of the used article based on the information regarding the trade-in quotation request, and sends quotation information including the trade-in quote of the used article, to the user computer;

a storage control module that sends to the user computer either of the information regarding the trade-in quotation request of the used article or the trade-in quote of the used article in a specific format that allows for storage in the user computer; and

a trade-in procedure execution module that, in the case where either of the information regarding the trade-in quotation request of the used article or the trade-in quote of the used article has been stored in the user computer, makes a trade-in procedure of the used article without requiring the user computer to reenter the information regarding the trade-in quotation request of the used article, after the user completes a product purchase procedure.

The used article quotation system of the invention receives information regarding a trade-in quotation request of the used article from a user computer, determines a trade-in quote of the used article based on the information regarding the trade-in quotation request, and sends quotation information including the trade-in quote of the used article, to the user computer. The used article quotation system then sends to the user computer either of the information regarding the trade-in quotation request of the used article or the trade-in quote of the used article in a specific format that allows for storage in the user computer. In the case where either of the information regarding the trade-in quotation request of the used article or the trade-in quote of the used article has been stored in the user computer, the used article quotation system makes a trade-in procedure of the used article without requiring the user computer to reenter the information regarding the trade-in quotation request of the used article, after the user completes a product purchase procedure. This arrangement does not require the user to enter identical pieces of information many times for a trade-in of the used article and thereby effectively saves the time and the labor of the user.

The used article quotation method of the invention may be actualized in the form of a used article quotation program. The present invention is accordingly directed to a used article quotation program that is executed for a trade-in of a used article from a user. The used article quotation program causes a server computer, which is connected with a user computer in a communicable manner, to attain the functions of: (a) receiving information regarding a trade-in quotation request of the used article from the user computer, determining a trade-in quote of the used article based on the information regarding the trade-in quotation request, and sending quotation information including the trade-in quote of the used article, to the user computer; (b) sending to the user computer either of the information regarding the trade-in quotation request of the used article or the trade-in quote of the used article in a specific format that allows for storage in the user computer; and (c) in the case where either of the information regarding the trade-in quotation request of the used article or the trade-in quote of the used article has been stored in the user computer, making a trade-in procedure of the used article without requiring the user computer to reenter the information regarding the trade-in quotation request of the used article, after the user completes a product purchase procedure.

The used article quotation program may be recorded in a computer readable recording medium (for example, a hard disk, a ROM, an FD, a CD, or a DVD), may be transferred from one computer to another computer via a transfer medium (a communication network like the Internet or a LAN), or may be transmitted in any other suitable form. The server computer executes this program to attain the used article quotation method discussed above and thereby exerts the similar functions and effects to those of the used article quotation method and the server management method discussed above. In the server computer of the invention, only one computer may execute all the procedures or multiple computers may share execution of the procedures.

### BRIEF DESCRIPTION OF THE DRAWINGS

FIGS. 1 through 8 illustrate a first embodiment;

FIG. 1 schematically illustrates the construction of a used article quotation system in a first embodiment of the invention;

FIG. 2 shows a database including values of components stored in a data storage device;

FIG. 3 shows a time-series process of communication;

FIG. 4 shows an example of the quotation requirement information input window;

FIG. 5 is a flowchart showing a quotation window creation routine;

FIGS. 6 through 8 show one example of the quotation window;

FIGS. 9 through 15 illustrate a second embodiment;

FIG. 9 shows a time-series process of communication;

FIG. 10 is a flowchart showing a quotation window creation routine;

FIG. 11 shows the settings of the quote relative to the threshold values;

FIGS. 12 through 15 show one example of the quotation window;

FIGS. 16 through 23 illustrate a third embodiment;

FIG. 16 schematically illustrates the construction of a server system in a third embodiment of the invention;

FIG. 17 shows a process of communication at a used article quotation site;

FIG. 18 shows one example of the quotation window;

FIG. 19 shows a time-series process of communication in the shopping site;

FIG. 20 shows one example of the trade-in check window;

FIG. 21 shows one example of the purchase requirement information input window;

FIG. 22 shows one example of the trade-in requirement information input window; and

FIG. 23 shows a time-series of process in each site.

### DESCRIPTION OF THE PREFERRED EMBODIMENTS

Preferred embodiments of the invention are discussed below with reference to the accompanied drawings.

### First Embodiment

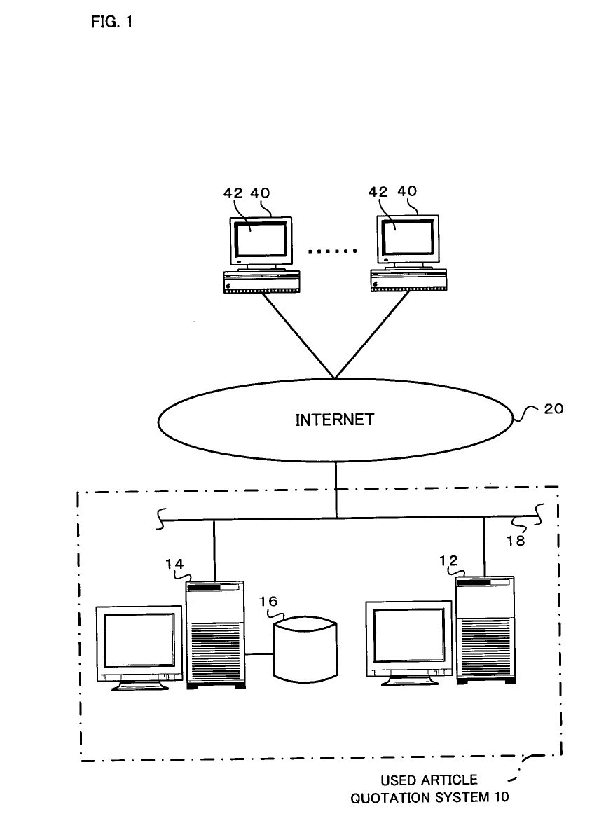

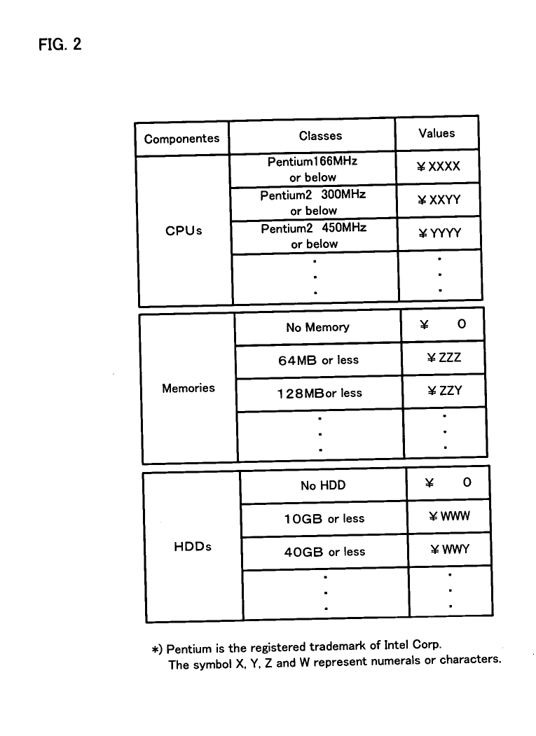

FIG. 1 schematically illustrates the construction of a used article quotation system 10 in a first embodiment of the invention, and FIG. 2 shows a database stored in a data storage device 16 connecting with a database server 14 included in the used article quotation system 10.

The used article quotation system 10 of this embodiment includes a Web server 12 and a database server 14, which are mutually connected in a communicable manner via a network cable 18.

The Web server 12 opens a used article quotation site, which shows quotes of each used personal computer owned by each user. The Web server 12 works as a contact for requests from user computers 40 connecting with the Internet 20. The Web server 12 functions to receive a request from each of the user computers 40, make a reply to the request, and transmit the reply to the user computer 40. The Web server 12 also functions to receive information required for quotation (hereafter referred to as quotation requirement information) from each of the user computers 40, transfer the quotation requirement information to the database server 14, activate the database server 14 to compute a cash-out quote, receive a result of the computation, make a reply based on the received computation result, and transfer the reply to the user computer 40. The quotation requirement information represents information on classes and performances of components constituting used personal computers, as discussed in detail later.

A data storage device 16 is connected to the database server 14 and stores a component quote table, in which component names and respective classes of components included in used personal computers are mapped to values, as shown in FIG. 2. The components of the personal computers are grouped by the component names, such as CPUs, memories, HDDs, FDDs CD-ROMs, LAN cards, instruction manuals, and packages. The CPUs are further classified into classes by the name of the processor and the clock frequency, and the values are set for the respective classes. The memories and the HDDs are classified into classes by their capacities, and the values are set for the respective classes. Although not being specifically illustrated, the CD-ROMs are classified into classes by the function (for example, a DVD readable function or a DVD writable function), and the values are set for the respective classes. The values of the FDDs, the LAN cards, the instruction manuals, and the packages do not depend upon their classes but are set according to their presence or absence.

The database server 14 is connected with the data storage device 16. The database server 14 functions to retrieve the data storage device 16, based on the quotation requirement information regarding each used personal computer, which has been received from each of the user computers 40 via the Web server 12, compute a total value of respective used components as a maximum cash-out quote PAmax, and transfer the computed maximum cash-out quote PAmax to the Web server 12.

The user computer 40 is a known general-purpose personal computer used by either an individual or a legal entity. The user computer 40 utilizes a Web browser installed therein to gain access to the used article quotation site opened by the Web server 12 via the Internet 20. The user computer 40 makes various pieces of information shown on the display 42.

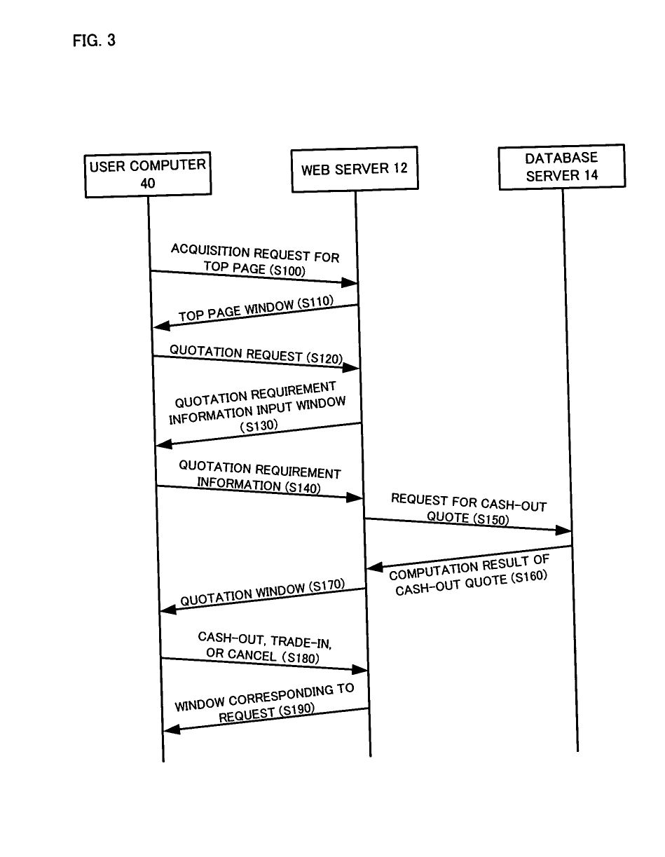

The used article quotation system 10 of the embodiment is operated in the manner discussed below. FIG. 3 shows a time series process of communication between the Web server 12, the database server 14, and the user computer 40.

The user activates the Web browser on the user computer 40 and inputs a URL (Uniform Resource Locator) of the used article quotation site opened by the Web server 12. The user computer 40 then sends an acquisition request for a top page of the used article quotation site to the Web server 12 via the Internet 20 (step S100). The Web server 12 receives the acquisition request and transmits a top page window (not shown) of the used article quotation site to the user computer 40 via the Internet 20 (step S110). The user computer 40 opens the received top page window of the used article quotation site on the display 42.

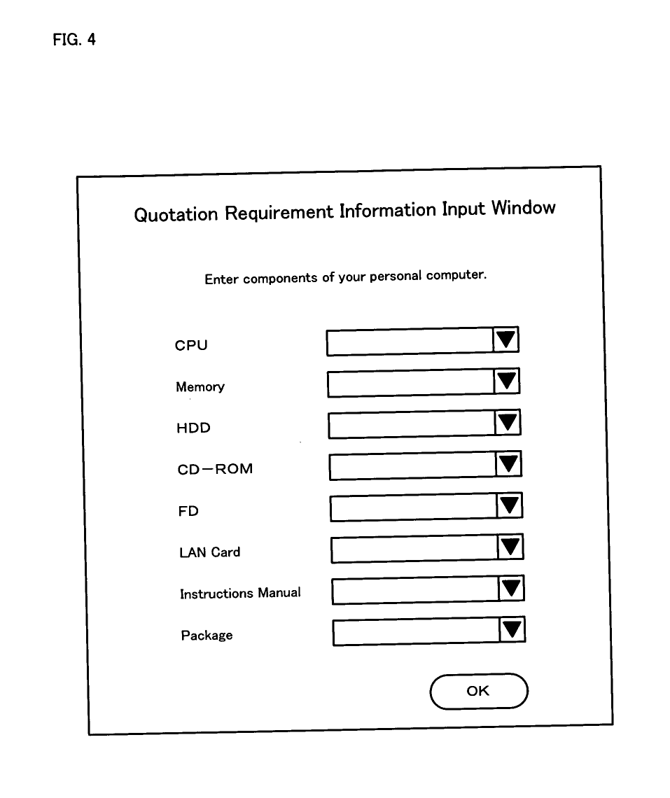

When the user clicks a quotation request button provided on the top page window of the used article quotation site, the user computer 40 sends a quotation request to the Web server 12 via the Internet 20 (step S120). The Web server 12 receives the quotation request and transmits a quotation requirement information input window to the user computer 40 via the Internet 20 (step S130). The user computer 40 opens the received quotation requirement information input window on the display 42. Here the quotation requirement information is information required for quotation of each used personal computer and represents information on the respective components of each used personal computer. FIG. 4 shows an example of the quotation requirement information input window. In this illustrated example, the user opens respective pull-down menus and selects entries of the processor name and the clock frequency for the CPU, of the capacities for the memory and the HDD, of the function (for example, a DVD readable function or a DVD writable function) for the CD-ROM, and of the presence or absence for the FDD, the LAN card, the instructions manual, and the package.

The user inputs information on the respective components on quotation requirement information input window and clicks an ‘OK’ button provided on the quotation requirement information input window (see FIG. 4). The user computer 40 then transmits the quotation requirement information to the Web server 12 via the Internet 20 (step S140). The Web server 12 receives the transmitted quotation requirement information and sends the quotation requirement information and a request signal for cash-out quote to the database server 14 (step S150). The database server 14 receives the request signal for cash-out quote and the quotation requirement information, refers to the component quote table (see FIG. 2) stored in the data storage device 16 based on the quotation requirement information, and computes the maximum cash-out quote PAmax. The concrete procedure of computation reads the value mapped to the processor name of the CPU and the clock frequency, the value mapped to the capacity of the memory, the value mapped to the capacity of the HDD, and the other additional values from the component quote table shown in FIG. 2 and calculates the total of these values of the components according to Equation 1 given below as the maximum cash-out quote PAmax:

PAmax=Σ(Values of Components) [Equation 1]

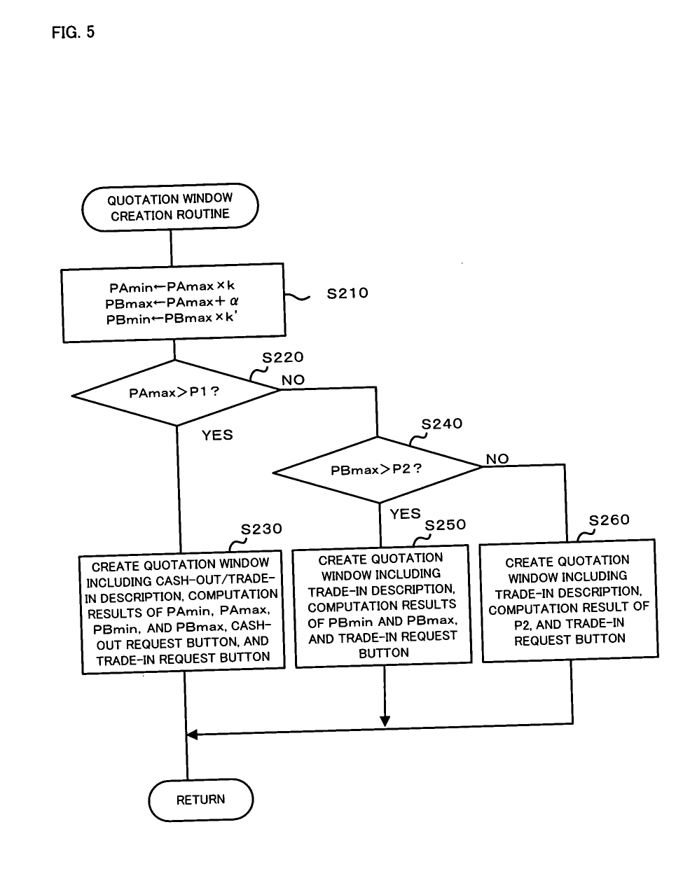

After computation of the maximum cash-out quote PAmax, the database server 14 transmits the computed maximum cash-out quote PAmax to the Web server 12 (step S160). The Web server 12 receives the transmitted maximum cash-out quote PAmax and executes a quotation window creation routine shown in the flowchart of FIG. 5. When the quotation window creation routine starts, the Web server 12 first calculates a minimum cash-out quote PAmin, a maximum trade-in quote PBmax, and a minimum trade-in quote PBmin from the maximum cash-out quote PAmax received from the database server 14 (step S210). One example of equations for calculating the respective values are given as Equations 2 below:

PAmin=PAmax×k

PBmax=PAmax+α

PBmin=PBmax×k′ [Equation 2]

(where k<1, k′<1, and α>0)

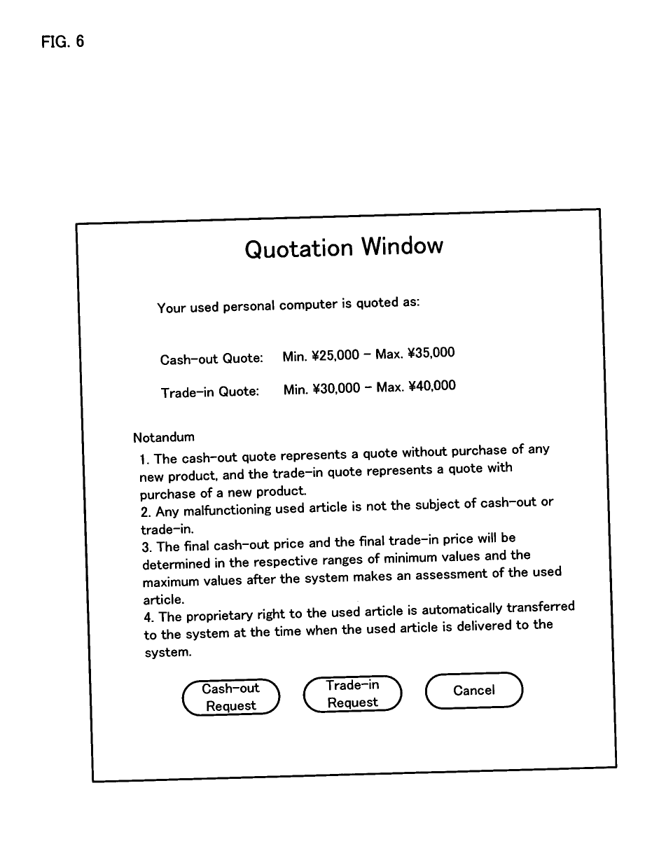

The maximum cash-out quote PAmax is compared with a threshold value P1 (step S220). The threshold value P1 is set to a specified value of criterion for determining that a used article alone is not worth being redeemed by the used article quotation system 10, when the maximum cash-out quote PAmax is not greater than the threshold value P1. When the maximum cash-out quote PAmax exceeds the threshold value P1, it is determined that the used article is worth of both a cash-out without purchase of any new product and a trade-in with purchase of a new product. The Web server 12 accordingly creates a quotation window including cash-out and trade-in description, the minimum cash-out quote PAmin, the maximum cash-out quote PAmax, the minimum trade-in quote PBmin, the maximum trade-in quote PBmax, a Cash-out Request button, a Trade-in Request button, and a Cancel button (step S230). The program then exits from this quotation window creation routine. One example of the quotation window created in this case is shown in FIG. 6. The cash-out and trade-in description shows that the cash-out quote represents a quote without purchase of any new product, that the trade-in quote represents a quote with purchase of a new product, that any malfunctioning used article is not the subject of cash-out or trade-in, that the final cash-out price and the final trade-in price will be determined in the respective ranges of minimum values and maximum values after the system makes an assessment of the used article, and that the proprietary right to the used article is automatically transferred to the system at the time when the used article is delivered to the system (see ‘Notandum’ in the quotation window of FIG. 6).

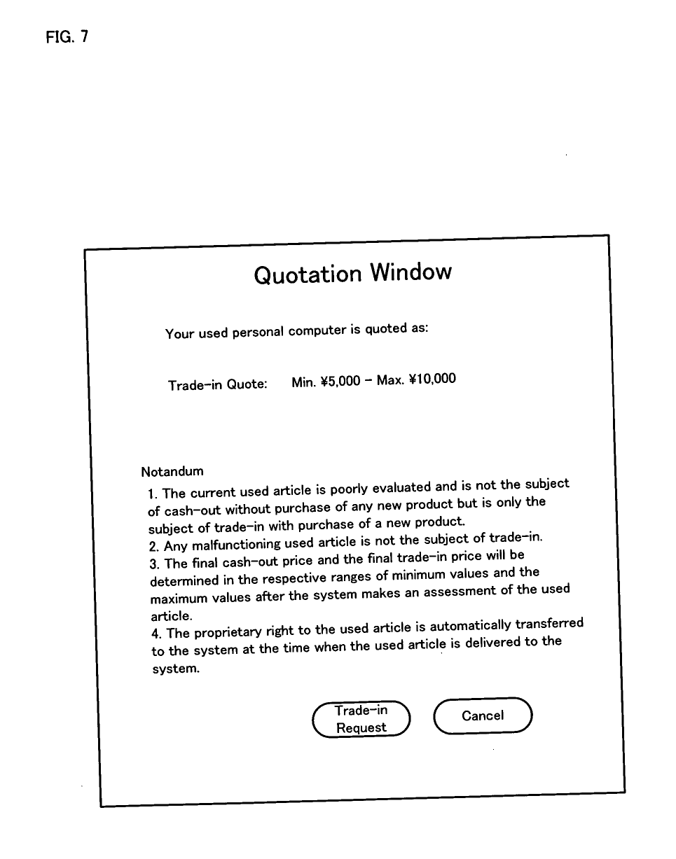

When the maximum cash-out quote PAmax is not greater than the threshold value P1 at step S220, on the other hand, it is determined that the used article is not worth of a cash-out without purchase of any new product but is worth of a trade-in with purchase of a new product. The maximum trade-in quote PBmax is then compared with a threshold value P2 (step S240). The threshold value P2 is set to a specified value of criterion for determining that the used article quotation system 10 is not required to set a certain width for the trade-in quote of the used article, when the maximum trade-in quote PBmax is not greater than the threshold value P2. When the maximum trade-in quote PBmax exceeds the threshold value P2, it is determined that the used article quotation system 10 is required to set a certain width for the trade-in quote with purchase of a new product. The Web server 12 accordingly creates a quotation window including trade-in description, the minimum trade-in quote PBmin, the maximum trade-in quote PBmax, the Trade-in Request button, and the Cancel button (step S250). The program then exits from this quotation window creation routine. One example of the quotation window created in this case is shown in FIG. 7. The trade-in description shows that the current used article is poorly evaluated and is not the subject of cash-out without purchase of any new product but is only the subject of trade-in with purchase of a new product, that any malfunctioning used article is not the subject of trade-in, that the final trade-in price will be determined in the range of a minimum value and a maximum value after the system makes an assessment of the used article, and that the proprietary right to the used article is automatically transferred to the system at the time when the used article is delivered to the system (see ‘Notandum’ in the quotation window of FIG. 7).

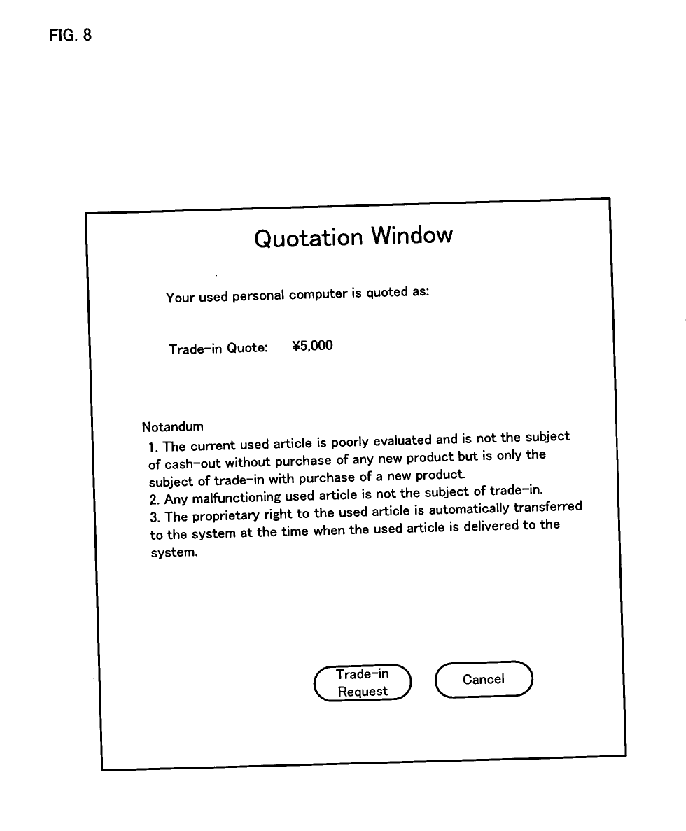

When the maximum trade-in quote PBmax is not greater than the threshold value P2 at step S240, on the other hand, it is determined that the used article quotation system 10 is not required to set a certain width for the trade-in quote of the used article. The Web server 12 accordingly sets a fixed price P2 (this is identical with the threshold value P2 at step S240) to the trade-in quote and creates a quotation window including trade-in description, the fixed trade-in quote P2, the Trade-in Request button, and the Cancel button (step S260). The program then exits from this quotation window creation routine. One example of the quotation window created in this case is shown in FIG. 8. The trade-in description shows that the current used article is poorly evaluated and is not the subject of cash-out without purchase of any new product but is only the subject of trade-in with purchase of a new product, that any malfunctioning used article is not the subject of trade-in, and that the proprietary right to the used article is automatically transferred to the system at the time when the used article is delivered to the system (see ‘Notandum’ in the quotation window of FIG. 8). In this case, the used article is not assessed but is taken as a trade-in with the fixed trade-in quote P2. After conclusion of the quotation window creation routine, the program goes back to the processing routine of FIG. 3. The Web server 12 sends the quotation window thus created to the user computer 40 (step S170). The user computer 40 opens the received quotation window on the display 42.

For example, the quotation window shown in FIG. 6 is opened on the display 42. The user compares the cash-out quote with the trade-in quote on the quotation window and especially makes comparison between the minimum cash-out and trade-in quotes and between the maximum cash-out and trade-in quotes. The user clicks the ‘Cash-out Request’ button to effectuate a cash-out, the ‘Trade-in Request’ button to effectuate a trade-in, or the ‘Cancel’ button to throw up a cash-out and a trade-in. The user computer 40 respectively sends a cash-out request signal, a trade-in request signal, or a cancellation request signal to the Web server 12 via the Internet 20 in response to the click of the ‘Cash-out Request’ button, the ‘Trade-in Request’ button, or the ‘Cancel’ button (step S180). The Web server 12 receives one of the cash-out request, the trade-in request, and the cancellation request signals, analyzes the received request signal, and sends a window corresponding to the analyzed request signal to the user computer 40 (step S190). When the received signal represents the cash-out request, the Web server 12 sends a cash-out requirement information input window (not shown) to receive the user's entry of cash-out requirement information for cash-out of the used article, to the user computer 40. When the received signal represents the trade-in request, the Web server 12 connects the user computer 40 to a product purchase site (not shown) where the user can purchase new products. When the received signal represents the cancellation request, the Web server 12 sends the top page window of the used article quotation site to the user computer 40. The cash-out requirement information includes the user's postal address, the telephone number, the e-mail address, the postal address of a pickup location when the pickup location of the used article is different from the user's postal address, the name of the representative at the pickup location, and the telephone number of the pickup location.

In another example, the quotation window shown in FIG. 7 or shown in FIG. 8 is opened on the display 42. The user reads the notandum to acknowledge that the current used article is poorly evaluated and is not the subject of cash-out without purchase of any new product but is only the subject of trade-in with purchase of a new product, and clicks the ‘Trade-in Request’ button to effectuate a trade-in or the ‘Cancel’ button to throw up a trade-in. The user computer 40 respectively sends the trade-in request signal or the cancellation request signal to the Web server 12 via the Internet 20 in response to the click of the ‘Trade-in Request’ button or the ‘Cancel’ button (step S180). The Web server 12 receives either of the trade-in request or the cancellation request signals, analyzes the received request signal, and sends a window corresponding to the analyzed request signal to the user computer 40 (step S190). When the received signal represents the trade-in request, the Web server 12 connects the user computer 40 to the product purchase site where the user can purchase new products. When the received signal represents the cancellation request, the Web server 12 sends the top page window of the used article quotation site to the user computer 40.

The respective constituents of this embodiment are mapped to the elements of the present invention. The Web server 12 and the database server 14 of the embodiment correspond to the quote determination module of the invention, the Web server 12 corresponds to the quotation information transmission module. The value range where the maximum cash-out quote PAmax exceeds the threshold value P1 corresponds to the allowable cash-out value range. The contents of the quotation window correspond to the quotation information, the Cash-out Request button corresponds to the cash-out option, and the Trade-in Request button corresponds to the trade-in option.

As discussed above, the used article quotation system 10 of the embodiment receives a quotation request for a used personal computer and the quotation requirement information, which is required for quotation, from one of the user computers 40 and specifies the minimum cash-out quote PAmin, the maximum cash-out quote PAmax, the minimum trade-in quote PBmin, and the maximum trade-in quote PBmax of the used article, based on the received quotation requirement information. When the cash-out quote is in the allowable cash-out value range, the quotation window shown in FIG. 6 is sent to the user computer 40. The user compares the trade-in quote with the cash-out quote and utilizes the result of the comparison as an index for determining whether the used article is to be taken as a trade-in or to be cashed out. The arrangement of the embodiment desirably allows for comparison between the minimum trade-in quote and the minimum cash-out quote and between the maximum trade-in quote and the maximum cash-out quote to give the effective index.

The setting of the trade-in quote is advantageous over the setting of the cash-out trade. The user is accordingly expected to request the system's acceptance of the user's own used article at the trade-in quote and to purchase a new product. This arrangement takes advantage of a chance of accepting the used article from the user and thereby motivates the user to purchase products.

After computation of the maximum cash-out quote PAmax, the minimum cash-out quote PAmin, the maximum trade-in quote PBmax, and the minimum trade-in quote PBmin are calculated from the maximum cash-out quote PAmax. This arrangement facilitates specification of the trade-in quote advantageous over the cash-out quote.

The used article quotation system 10 clearly recognizes the user's request for acceptance of the used article at the cash-out quote without purchase of any new product, in response to the user's selection of the Cash-out Request button on the quotation window shown in FIG. 6. The used article quotation system 10 also clearly recognizes the user's request for acceptance of the used article at the trade-in quote with purchase of a new product, in response to the user's selection of the Trade-in Request button on the quotation window.

When the maximum cash-out quote PAmax is out of the allowable cash-out value range at step S220 in the flowchart of FIG. 5, the program proceeds to either step S250 or step S260 to create the quotation window excluding the cash-out quote as shown in FIG. 7 or shown in FIG. 8. The used article is, however, still worth of a trade-in with purchase of a new product for the used article quotation system 10. The quotation window accordingly shows the trade-in quote. The user is thus expected to request the system's acceptance of the user's own used article at the trade-in quote and to purchase a new product. This arrangement takes advantage of a chance of accepting the used article from the user and thereby motivates the user to purchase products. In this situation, the Cash-out Request button is not provided on the quotation window. There is accordingly no possibility that the user mistakenly selects the Cash-out Request button.

The trade-in quote and the cash-out quote are set, based on the information regarding the components included in each used article. The value of each used article is thus quoted according to its components.

The first embodiment discussed above is only illustrative and not restrictive in any sense. There may be many modifications, changes, and alterations of the first embodiment.

The procedure of the first embodiment reads the values of the respective components of each used personal computer from the component quote table and computes the total of the values of the components as the maximum cash-out quote PAmax. One possible modification may compute the total of the values of the components as the minimum cash-out quote PAmin and determine the other quotes PAmax, PBmax, and PBmin, based on the minimum cash-out quote PAmin. Another possible modification may compute the total of the values of the components as the maximum trade-in quote PBmax and determine the other quotes PAmax, PAmin, and PBmin, based on the maximum trade-in quote PBmax. Still another possible modification may compute the total of the values of the components as the minimum trade-in quote PBmin and determine the other quotes PAmax, PAmin, and PBmax, based on the minimum trade-in quote PBmin. In order to make the value range between the minimum trade-in quote PBmin and the maximum trade-in quote PBmax higher than the value range between the minimum cash-out quote PAmin and the maximum cash-out quote PAmax, another modified technique may add or subtract an offset value (>0) to or from the total of the values of the components, multiply the total of the values of the components by a coefficient of greater than 1 or by a coefficient of smaller than 1, or use any suitable arithmetic expressions.

The procedure of the embodiment compares the maximum cash-out quote PAmax with the threshold value P1 and determines that the maximum cash-out quote PAmax is in the allowable cash-out value range when PAmax exceeds P1. One possible modification may compare the minimum cash-out quote PAmin with a threshold value P1′ and determine that the minimum cash-out quote PAmin is in the allowable cash-out value range when PAmin exceeds P′.

The procedure of the above embodiment sets the minimum cash-out quote PAmin, the maximum cash-out quote PAmax, the minimum trade-in quote PBmin, and the maximum trade-in quote PBmax. One possible modification may set fixed prices to the cash-out quote and the trade-in quote without any width.

In one modification of the first embodiment, when receiving the trade-in request from the user computer 40 at step S180 in the processing routine of FIG. 3, the Web server 12 may store a trade-in specification, which includes the quotation requirement information received at step S140 and the minimum trade-in quote PBmin and the maximum trade-in quote PBmax included in the quotation window, into a trade-in specification storage device (not shown) connecting with the Web server 12. In this modified structure, after the product purchase site is sent to the user computer 40 at step S190, the Web server 12 may read the trade-in specification from the trade-in specification storage device, in response to the user's purchase request on the product purchase site received from the user computer 40, and send a window for asking the user to desire a trade-in under the conditions defined by the trade-in specification to the user computer 40. The user is only required to check the trade-in specification given at the time of a quotation request, in the case where the user desires to trade in the user's own used article and purchase a new product. This arrangement saves the user's labor and time of sending a quotation request for the same used article again, thus enhancing the convenience.

The procedure of the above embodiment computes the maximum cash-out quote PAmax by referring to the component quote table and determines the maximum trade-in quote PBmax, based on the maximum cash-out quote PAmax. One modification may prepare a component quote table including both a maximum cash-out price and a maximum trade-in price corresponding to each component and compute both the maximum cash-out quote PAmax and the maximum trade-in quote PBmax, based on the component quote table. Another modification may prepare a component quote table including a minimum cash-out price and a minimum trade-in price corresponding to each component and compute both the minimum cash-out quote PAmin and the minimum trade-in quote PBmin according to the component quote table.

The above embodiment regards the used personal computers. The technique of the invention is also applicable to a diversity of other used articles and provides a cash-out quote and a trade-in quote for each used article in response to a quotation request. Such used articles include used peripheral equipment of personal computers like displays, printers, and scanners, used office automation equipment like photocopiers, facsimiles, and paper shredders, used home electric appliances like television sets, refrigerators, washing machines, and microwave ovens, used vehicles like automobiles, motorbikes, bicycles, and boats, used sports equipment including golf clubs, tennis rackets, skies, and snowboards, and existing homes like apartments and houses.

In the structure of the embodiment discussed above, the used article quotation system 10 includes two servers, the Web server 12 and the database server 14. The used article quotation system may have only one server, where the Web server 12 has the functions of both the database server 14 and the Web server 12. The used article quotation system may otherwise include three or more servers.

### Second Embodiment

The used article quotation system 10 of the second embodiment includes the Web server 12 and the database server 14, which are mutually connected in a communicable manner via the network cable 18, as in the structure of the first embodiment. The respective constituents of the second embodiment are identical with those of the first embodiment and are thus not specifically described. The database server 14 of the second embodiment, however, has some difference from the database server 14 of the first embodiment. The database server 14 of the second embodiment retrieves the data storage device 16 based on the quotation requirement information on the user's own used personal computer, which has been received from the user computer 40 via the Web server 12, computes the total of the values of the used components included in the used personal computer as the minimum cash-out quote PAmin, and transfers the computed minimum cash-out quote PAmin to the Web server 12.

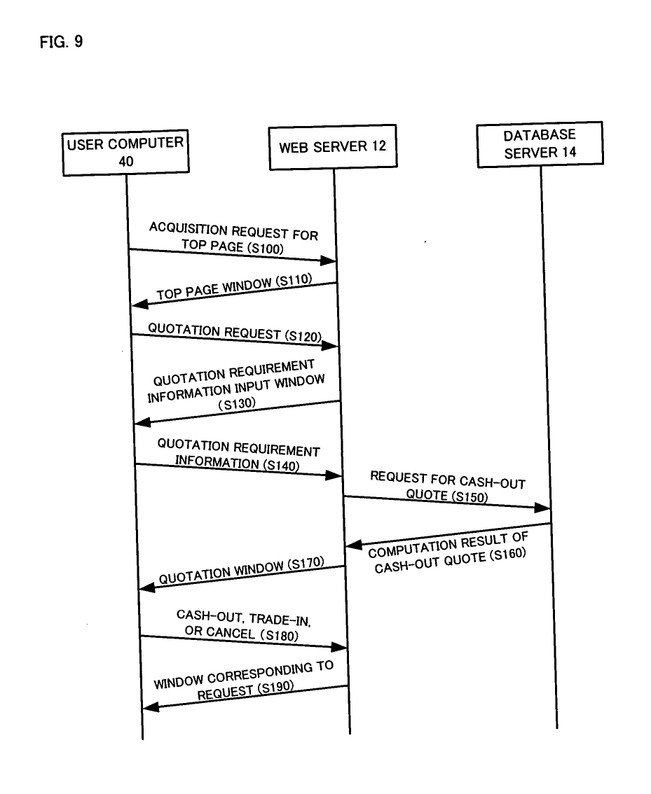

The used article quotation system 10 of the second embodiment is operated in the manner discussed below. FIG. 9 shows a time series process of communication between the Web server 12, the database server 14, and the user computer 40. Steps S100 through S150 of the second embodiment shown in the processing routine of FIG. 9 are identical with steps S100 through S150 of the first embodiment shown in the processing routine of FIG. 3 and are thus not specifically described here. The database server 14 receives the request signal for cash-out quote together with the quotation requirement information from the Web server 12 at step S150. The database server 14 refers to the component quote table (see FIG. 2) stored in the data storage device 16 based on the quotation requirement information, and computes the minimum cash-out quote PAmin. The concrete procedure of computation reads the value mapped to the processor name of the CPU and the clock frequency, the value mapped to the capacity of the memory, the value mapped to the capacity of the HDD, and the other additional values from the component quote table shown in FIG. 2 and calculates the total of these values of the components according to Equation 3 given below as the minimum cash-out quote PAmin.

PAmin=Σ(Values of Components) [Equation 3]

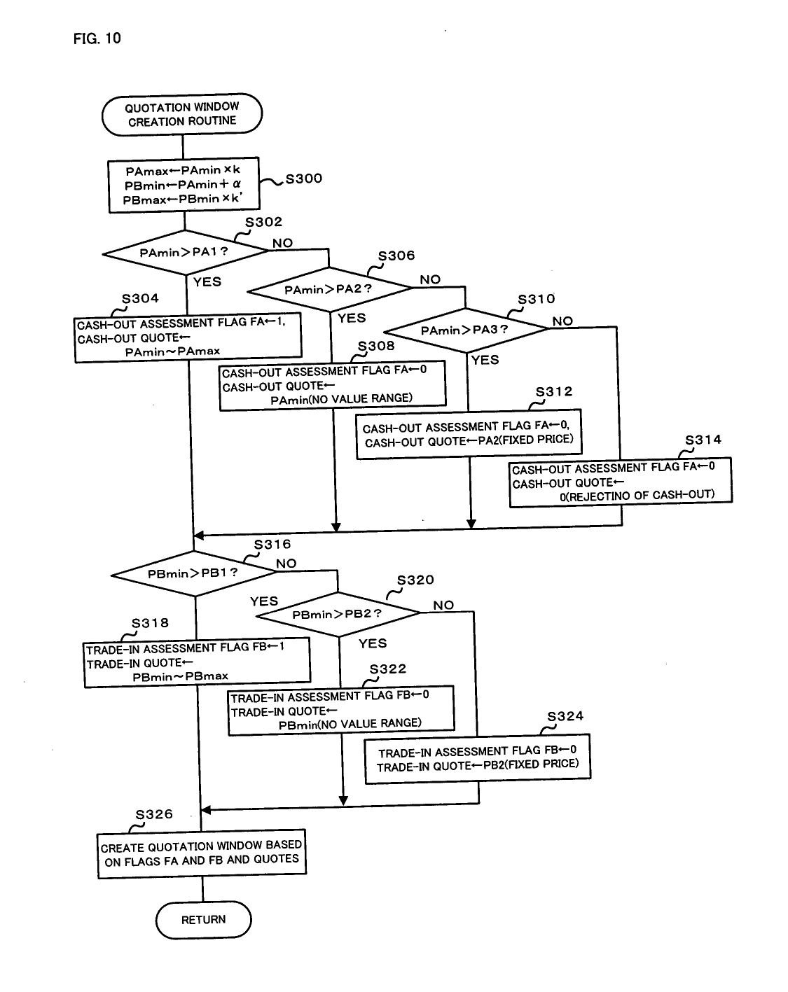

After computation of the minimum cash-out quote PAmin, the database server 14 transmits the computed minimum cash-out quote PAmin to the Web server 12 (step S160). The Web server 12 receives the transmitted minimum cash-out quote PAmin and executes a quotation window creation routine shown in the flowchart of FIG. 10. When the quotation window creation routine starts, the Web server 12 first calculates a maximum cash-out quote PAmax, a minimum trade-in quote PBmin, and a maximum trade-in quote PBmax from the minimum cash-out quote PAmin received from the database server 14 (step S300). One example of equations for calculating the respective values are given as Equations 4 below:

[Equations 4]

PAmax=PAmin×k

PBmin=PAmin+α

PBmax=PBmin×k′

(where k>1, k′>1, and α>0)

The minimum cash-out quote PAmin is first compared with a threshold value PA1 (step S302). The threshold value PA1 is set as an assessment requirement judgment value. When the minimum cash-out quote PAmin exceeds the threshold value PA1, the final cash-out price is determined, based on assessment of the used personal computer. When the minimum cash-out quote PAmin is not greater than the threshold value PA1, on the other hand, the final cash-out price is determined without assessment of the used personal computer. When the minimum cash-out quote PAmin exceeds the threshold value PA1 at step S302, a cash-out assessment flag FA is set equal to a value ‘1’, which represents requirement of assessment for determination of the final cash-out price, and the cash-out quote is set to have a value range between the minimum cash-out quote PAmin and the maximum cash-out quote PAmax (step S304). In this case, the final cash-out price is determined in the range from the minimum cash-out quote PAmin to the maximum cash-out quote PAmax, based on assessment of the used personal computer.

When the minimum cash-out quote PAmin is not greater than the threshold value PA1 at step S302, on the other hand, the minimum cash-out quote PAmin is then compared with another threshold value PA2 (step S306). The threshold value PA2 is smaller than the threshold value PA1 and is set as a value level criterion to measure the value level of the minimum cash-out quote PAmin. When the minimum cash-out quote PAmin exceeds the threshold value PA2, the cash-out assessment flag FA is set equal to a value ‘0’, which represents no requirement of assessment for determination of the final cash-out price, and the minimum cash-out quote PAmin is set to the cash-out quote (step S308). In this case, the cash-out price is fixed to the minimum cash-out quote PAmin. The minimum cash-out quote PAmin is the firm cash-out price of the used personal computer without assessment. The minimum cash-out quote PAmin is computed by the database serve 14 as the total of the prices of the components included in the used personal computer. Namely the respective used personal computers have different values of the minimum cash-out quote PAmin.

When the minimum cash-out quote PAmin is not greater than the threshold value PA2 at step S306, on the other hand, the minimum cash-out quote PAmin is compared with still another threshold value PA3 (step S310). The threshold value PA3 is smaller than the threshold value PA2 and is set as a cash-out acceptability judgment value to determine whether the used personal computer is worth of a cash-out. When the minimum cash-out quote PAmin exceeds the threshold value PA3, the cash-out assessment flag FA is set equal to ‘0’, which represents no requirement of assessment for determination of the final cash-out price, and a fixed price PA2 (this is identical with the threshold value PA2) is set to the cash-out quote (step S312). In this case, the fixed price PA2 is set to the cash-out price. The fixed price PA2 is the firm cash-out price of the used personal computer without assessment. This fixed price PA2 does not depend upon the components of the used personal computer.

When the minimum cash-out quote PAmin is not greater than the threshold value PA3 at step S310, on the other hand, the cash-out assessment flag FA is set equal to ‘0’, which represents no requirement of assessment for determination of the final cash-out price, and a value ‘0’ is set to the cash-out quote (step S314). Setting of the value ‘0’ to the cash-out quote means that the current used personal computer is not worth of a cash-out and that the cash-out of the used personal computer is rejected.

After completion of the setting of the cash-out assessment flag FA and the cash-out quote at any of steps S304, S308, S312, and S314, the minimum trade-in quote PBmin is compared with a threshold value PB1 (step S316). The threshold value PB1 is set as an assessment requirement judgment value. When the minimum trade-in quote PBmin exceeds the threshold value PB1, the final trade-in price is determined, based on assessment of the used personal computer. When the minimum trade-in quote PBmin is not greater than the threshold value PB1, on the other hand, the final trade-in price is determined without assessment of the used personal computer. When the minimum trade-in quote PBmin exceeds the threshold value PA1 at step S316, a trade-in assessment flag FB is set equal to a value ‘1’, which represents requirement of assessment for determination of the final trade-in price, and the trade-in quote is set to have a value range between the minimum trade-in quote PBmin and the maximum trade-in quote PBmax (step S318). In this case, the final trade-in price is determined in the range from the minimum trade-in quote PBmin to the maximum trade-in quote PBmax, based on assessment of the used personal computer.

When the minimum trade-in quote PBmin is not greater than the threshold value PB1 at step S316, on the other hand, the minimum trade-in quote PBmin is then compared with another threshold value PB2 (step S320). The threshold value PB2 is smaller than the threshold value PB1 and is set as a value level criterion to measure the value level of the minimum trade-in quote PBmin. When the minimum trade-in quote PBmin exceeds the threshold value PB2, the trade-in assessment flag FB is set equal to a value ‘0’, which represents no requirement of assessment for determination of the final trade-in price, and the minimum trade-in quote PBmin is set to the trade-in quote (step S322). In this case, the trade-in price is fixed to the minimum trade-in quote PBmin. The minimum trade-in quote PBmin is the firm trade-in price of the used personal computer without assessment. The minimum trade-in quote PBmin is calculated from the minimum cash-out quote PAmin, which has been computed by the database serve 14 as the total of the prices of the components included in the used personal computer. Namely the respective used personal computers have different values of the minimum trade-in quote PBmin.

When the minimum trade-in quote PBmin is not greater than the threshold value PB2, the trade-in assessment flag FA is set equal to ‘0’, which represents no requirement of assessment for determination of the final trade-in price, and a fixed price PB2 (this is identical with the threshold value PB2) is set to the trade-in quote (step S324). In this case, the fixed price PB2 is set to the trade-in price. The fixed price PB2 is the firm trade-in price of the used personal computer without assessment. This fixed price PB2 does not depend upon the components of the used personal computer.

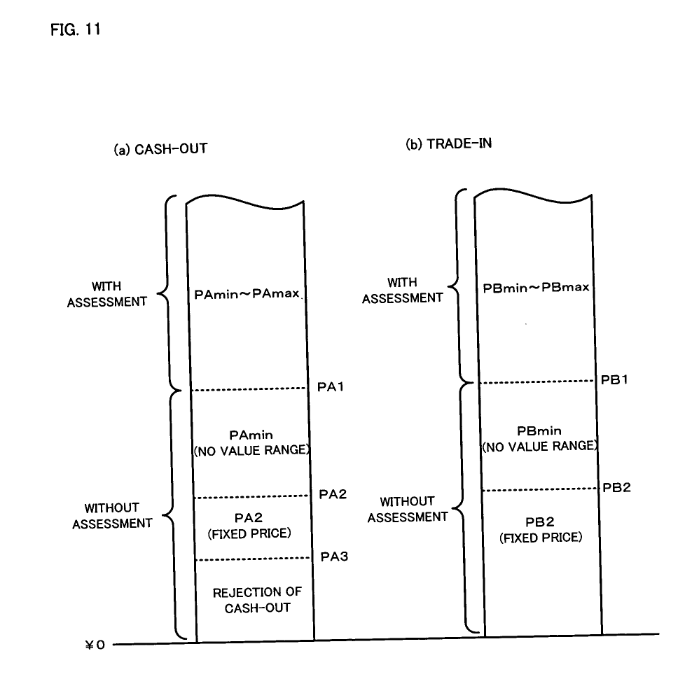

After completion of the setting of the trade-in assessment flag FB and the trade-in quote at any of steps S318, S322, and S324, the Web server 12 creates a quotation window, based on the respective settings of the cash-out assessment flag FA, the trade-in assessment flag FB, the cash-out quote, and the trade-in quote (step S326). The program then exits from this quotation window creation routine. FIG. 11 shows the settings of the cash-out quote relative to the threshold values PA1 through PA3 and the settings of the trade-in quote relative to the threshold values PB1 and PB2 at steps S302 through S324 in the flowchart of FIG. 10. The following discusses some examples of the quotation window created at step S326.

(1) In the Case of PAmin>PA1 and PBmin>PB1

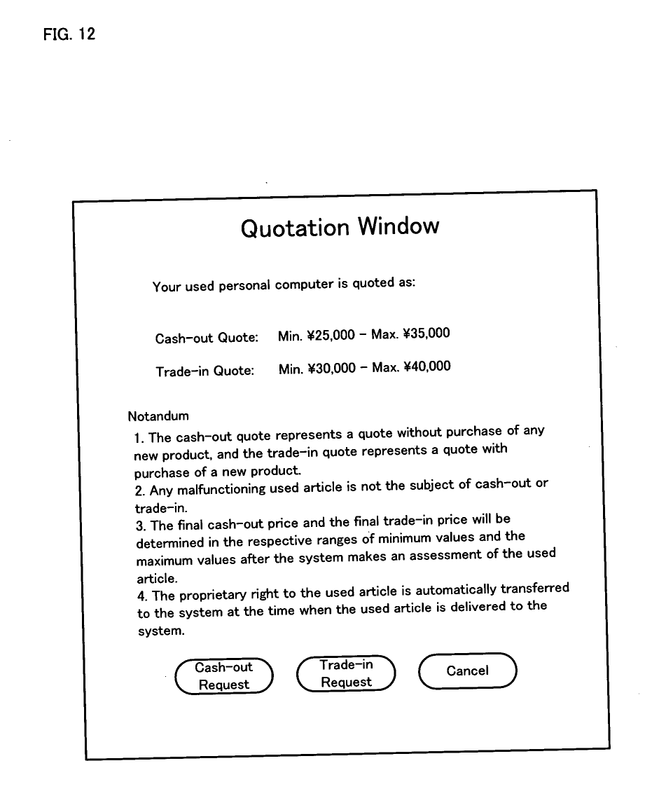

When the minimum cash-out quote PAmin exceeds the threshold value PA1 and the minimum trade-in quote PBmin exceeds the threshold value PB1, a value range between the minimum cash-out quote PAmin and the maximum cash-out quote PAmax and a value range between the minimum trade-in quote PBmin and the maximum trade-in quote PBmax are given respectively as the cash-out quote and the trade-in quote, as shown in the quotation window of FIG. 12. The quotation window of FIG. 12 also includes a description explaining a difference between the cash-out quote and the trade-in quote (see Notandum 1 in FIG. 12), a ‘Cash-out Request’ button and a ‘Trade-in Request’ button for selection, and a description showing that the final cash-out price and the final trade-in price will be determined based on the assessment of the used article (see Notandum 2 in FIG. 12). The quotation window of FIG. 12 further includes a description showing that any malfunctioning used article is not the subject of cash-out or trade-in (see Notandum 3) and a description of transfer of the proprietary right (see Notandum 4).

(2) In the Case of PA1≧PAmin>PA2 and PBmin>PB1

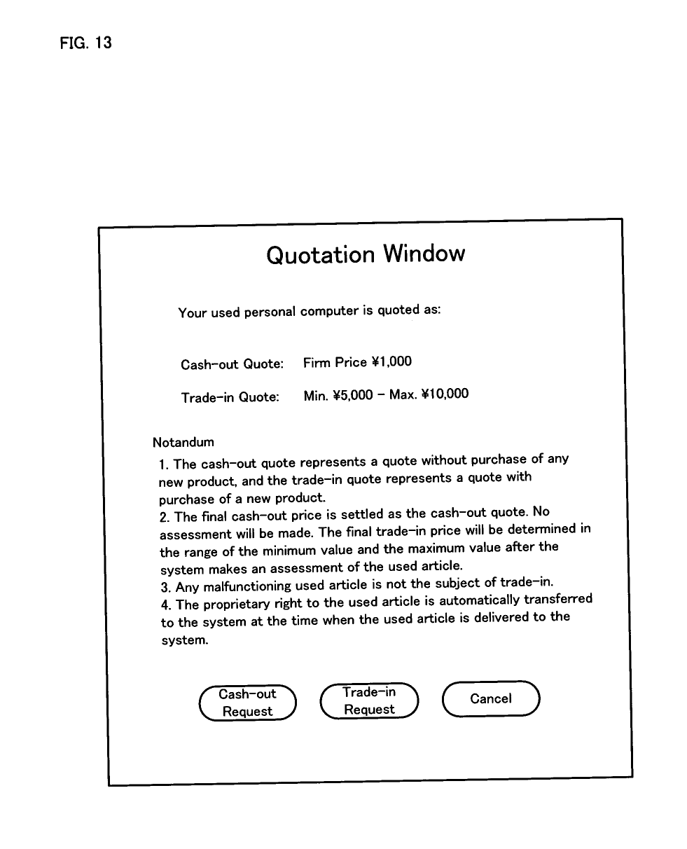

When the minimum cash-out quote PAmin is not greater than the threshold value PA1 but exceeds the threshold value PA2 and the minimum trade-in quote PBmin exceeds the threshold value PB1, the minimum cash-out quote PAmin (the settled price of no value range) is given as the cash-out quote and a value range between the minimum trade-in quote PBmin and the maximum trade-in quote PBmax is given as the trade-in quote, as shown in the quotation window of FIG. 13. The quotation window of FIG. 13 also includes a description explaining a difference between the cash-out quote and the trade-in quote (see Notandum 1 in FIG. 13), a ‘Cash-out Request’ button and a ‘Trade-in Request’ button for selection, and a description showing that the final cash-out price is settled as the cash-out quote but the final trade-in price will be determined based on the assessment of the used article (see Notandum 2 in FIG. 13). The quotation window of FIG. 13 further includes a description showing that any malfunctioning used article is not the subject of cash-out or trade-in (see Notandum 3) and a description of transfer of the proprietary right (see Notandum 4).

(3) In the Case of PA2≧PAmin>PA3 and PB1≧PBmin>PB2

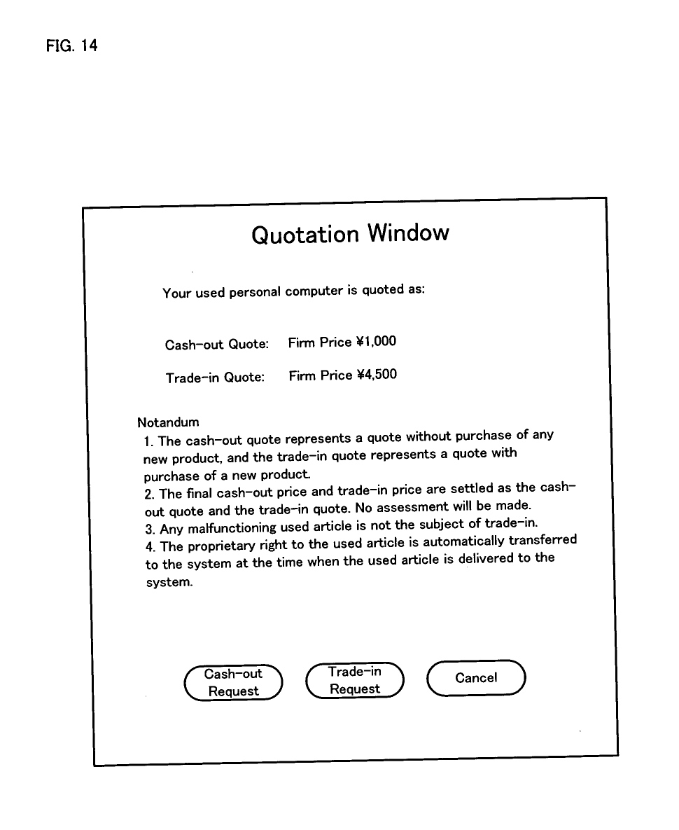

When the minimum cash-out quote PAmin is not greater than the threshold value PA2 but exceeds the threshold value PA3 and the minimum trade-in quote PBmin is not greater than the threshold value PB1 but exceeds the threshold value PB2, the fixed price PA2 (¥1,000 in the illustrated example) is given as the cash-out quote and the minimum trade-in quote PBmin is given as the trade-in quote, as shown in the quotation window of FIG. 14. The quotation window of FIG. 14 also includes a description explaining a difference between the cash-out quote and the trade-in quote (see Notandum 1 in FIG. 14), a ‘Cash-out Request’ button and a ‘Trade-in Request’ button for selection, and a description showing that the final cash-out price and the final trade-in price are settled as the cash-out quote and the trade-in quote (see Notandum 2 in FIG. 14). The quotation window of FIG. 14 further includes a description showing that any malfunctioning used article is not the subject of cash-out or trade-in (see Notandum 3) and a description of transfer of the proprietary right (see Notandum 4).

(4) In the Case of PA3≧PAmin and PB2≧PBmin

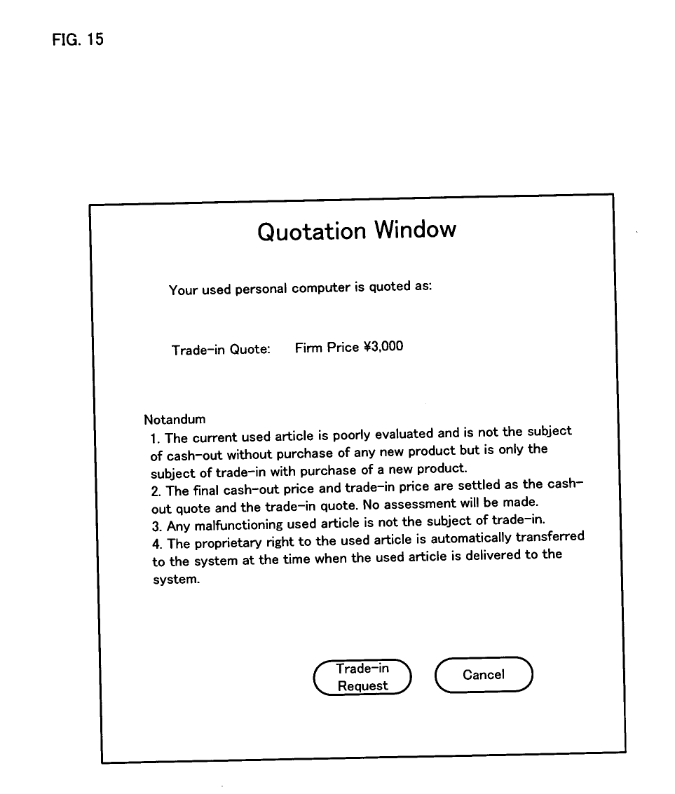

When the minimum cash-out quote PAmin is not greater than the threshold value PA3 and the minimum trade-in quote PBmin is not greater than the threshold value PB2, cash-out of the used article is rejected, as shown in the quotation window of FIG. 15. No cash-out quote is thus given, while the fixed price PB2 (¥3,000 in this illustrated example) is given as the trade-in quote. The quotation window of FIG. 15 also includes a description showing that the used article is not the subject of cash-out but is only the subject of trade-in (see Notandum 1 in FIG. 15), a ‘Trade-in Request’ button, and a description showing that the final trade-in price is settled as the trade-in quote (see Notandum 2 in FIG. 15). The quotation window of FIG. 15 further includes a description showing that any malfunctioning used article is not the subject of cash-out or trade-in (see Notandum 3) and a description of transfer of the proprietary right (see Notandum 4).

After conclusion of the quotation window creation routine, the program goes back to the processing routine of FIG. 9. The Web server 12 sends the quotation window thus created to the user computer 40 (step S170). The user computer 40 opens the received quotation window on the display 42. The user reads the contents displayed on the quotation window and clicks the ‘Cash-out Request’ button to effectuate a cash-out, the ‘Trade-in Request’ button to effectuate a trade-in, or the ‘Cancel’ button to throw up a cash-out and a trade-in. The user computer 40 respectively sends a cash-out request signal, a trade-in request signal, or a cancellation request signal to the Web server 12 via the Internet 20 in response to the click of the ‘Cash-out Request’ button, the ‘Trade-in Request’ button, or the ‘Cancel’ button (step S180). The Web server 12 receives one of the cash-out request, the trade-in request, and the cancellation request signals, analyzes the received request signal, and sends a window corresponding to the analyzed request signal to the user computer 40 (step S190). When the received signal represents the cash-out request, the Web server 12 sends a cash-out requirement information input window (not shown) to receive the user's entry of cash-out requirement information for cash-out of the used article, to the user computer 40. When the received signal represents the trade-in request, the Web server 12 connects the user computer 40 to the product purchase site where the user can purchase new products. When the received signal represents the cancellation request, the Web server 12 sends the top page window of the used article quotation site to the user computer 40. The quotation window of FIG. 15 does not include the ‘Cash-out Request’ button, so that the user can not select the cash-out request.

The respective constituents of the second embodiment are mapped to the elements of the present invention. The Web server 12 and the database server 14 of this embodiment correspond to the tentative quote setting module of the invention. The minimum cash-out quote PAmin and the minimum trade-in quote PBmin correspond to the tentative quote. The Web server 12 corresponds to the assessment requirement judgment module, the final quote setting module, and the quotation information transmission module. The minimum cash-out quote PAmin set as the cash-out price at step S308 and the minimum trade-in quote PBmin set as the trade-in price at step S322 in the flowchart of FIG. 10 correspond to the settled price of no value range without assessment of the used article, which is determined according to the tentative quote.

As discussed above, the used article quotation system 10 of the second embodiment may cash out or trade in a used personal computer at a settled price without assessment. In this case, the settled price is determined according to the tentative quote (the minimum cash-out quote PAmin or the minimum trade-in quote PBmin), that is, according to the value of the used personal computer. This method desirably heightens the user's satisfaction level. In the second embodiment, the settled price determined according to the tentative quote is set equal to the tentative quote.

In the case of cash-out or trade-in of the used personal computer without assessment, the system of the second embodiment does not uniformly fix the cash-out price or the trade-in price, regardless of the value of the used personal computer. The system specifies the value level of the used personal computer and selects either a settled price of no value range according to the value of the used personal computer or a fixed price regardless of the value of the used personal computer. This method desirably heightens the user's satisfaction level.

In the case where the used personal computer is highly evaluated, a value range between a minimum value and a maximum value is shown as the cash-out quote or the trade-in quote. In this case, the final cash-out price or the final trade-in price is determined based on the assessment. The minimum value is set as the cash-out price or the trade-in price when the assessment gives a poor result. The maximum value is set as the cash-out price or the trade-in price when the assessment gives a good result. The user takes into account these possibilities and determines the request for cash-out or trade-in or no deal.

The setting of the trade-in quote on the quotation window is advantageous over the setting of the cash-out trade. The user is accordingly expected to select a trade-in rather than a cash-out and to purchase a new product. This arrangement takes advantage of a chance of accepting the used article from the user and thereby motivates the user to purchase products. Especially a cash-out of a worthless used personal computer is rejected, while a trade-in of the same used personal computer is accepted. This further urges the user to select a trade-in rather than a cash-out.

The second embodiment discussed above is only illustrative and not restrictive in any sense. There may be many modifications, changes, and alterations of the second embodiment.

The procedure of the second embodiment reads the values of the respective components of each used personal computer from the component quote table and computes the total of the values of the components as the minimum cash-out quote PAmin. One possible modification may compute the total of the values of the components as the maximum cash-out quote PAmax, which corresponds to the tentative quote of the invention, and determine the other quotes PAmin, PBmax, and PBmin, based on the maximum cash-out quote PAmax. Another possible modification may compute the total of the values of the components as the minimum trade-in quote PBmin, which corresponds to the tentative quote of the invention, and determine the other quotes PAmax, PAmin, and PBmax, based on the minimum trade-in quote PBmin. Still another possible modification may compute the total of the values of the components as the maximum trade-in quote PBmax, which corresponds to the tentative quote of the invention, and determine the other quotes PAmax, PAmin, and PBmin, based on the maximum trade-in quote PBmax. In order to make the value range between the minimum trade-in quote PBmin and the maximum trade-in quote PBmax higher than the value range between the minimum cash-out quote PAmin and the maximum cash-out quote PAmax, another modified technique may add or subtract an offset value (>0) to or from the total of the values of the components, multiply the total of the values of the components by a coefficient of greater than 1 or by a coefficient of smaller than 1, or use any suitable arithmetic expressions.

The processing of steps S310 and S312 in the flowchart of FIG. 10 may be omitted from the procedure of the second embodiment. In this modified arrangement, when the minimum cash-out quote PAmin is not greater than the threshold value PA2, the program proceeds to step S314 to reject a cash-out of the used personal computer. Another modification may omit the processing of steps S320 and S324. When the minimum trade-in quote PBmin is not greater than the threshold value PB1 at step S316, the program proceeds to step S322 to set the minimum trade-in quote PBmin to the trade-in quote. Such modification does not set a fixed cash-out quote or a fixed trade-in quote regardless of the value of the used personal computer. This heightens the user's satisfaction level.

In the quotation window creation routine of the second embodiment shown in the flowchart of FIG. 10, when assessment of the used personal computer is not required (in the case of a negative answer at step S302 or at step S316) and when the tentative quote exceeds the value level criterion (in the case of a positive answer at step S306 or at step S320), the cash-out quote or the trade-in quote is fixed to the minimum cash-out quote PAmin or the minimum trade-in quote PBmin as the settled price of no value range, which is determined according to the tentative quote. A fixed value other than the minimum quote PAmin or PBmin may be adopted as the settled price. For example, the settled price may be a mean of the minimum quote and the maximum quote or may be the maximum quote. One possible application provides a table representing a mapping of the minimum quote as the tentative quote to the settled price and reads the settled price corresponding to the minimum quote from this table.

In the quotation window creation routine of the second embodiment shown in the flowchart of FIG. 10, when assessment of the used personal computer is not required (in the case of a negative answer at step S302 or at step S316) and when the tentative quote is not greater than the value level criterion (in the case of a negative answer at step S306 or at step S320), the cash-out quote or the trade-in quote is fixed to the threshold value PA2 or PB2 as the firm price. A fixed value other than the threshold value PA2 or PB2 may be adopted as the firm price.

The threshold value PA1 may be identical with or different from the threshold value PB1. The threshold values PA1 and PB1 may be set to make the trade-in quote advantageous over the cash-out quote. The threshold value PA2 may be identical with or different from the threshold value PB2. The threshold values PA2 and PB2 may be set to make the trade-in quote advantageous over the cash-out quote.

The procedure of the second embodiment computes the minimum cash-out quote PAmin by referring to the component quote table and determines the minimum trade-in quote PBmin, based on the minimum cash-out quote PAmin. One modification may prepare a component quote table including both a minimum cash-out price and a minimum trade-in price corresponding to each component and compute both the minimum cash-out quote PAmin and the minimum trade-in quote PBmin, based on the component quote table. Another modification may prepare a component quote table including a maximum cash-out price and a maximum trade-in price corresponding to each component and compute both the maximum cash-out quote PAmax and the maximum trade-in quote PBmax according to the component quote table.

The second embodiment regards the used personal computers. The technique of the invention is also applicable to a diversity of other used articles and provides a cash-out quote and a trade-in quote for each used article in response to a quotation request. Such used articles include used peripheral equipment of personal computers like displays, printers, and scanners, used office automation equipment like photocopiers, facsimiles, and paper shredders, used home electric appliances like television sets, refrigerators, washing machines, and microwave ovens, used vehicles like automobiles, motorbikes, bicycles, and boats, used sports equipment including golf clubs, tennis rackets, skies, and snowboards, and existing homes like apartments and houses.

In the structure of the second embodiment discussed above, the used article quotation system 10 includes two servers, the Web server 12 and the database server 14. The used article quotation system may have only one server, where the Web server 12 has the functions of both the database server 14 and the Web server 12. The used article quotation system may otherwise include three or more servers.

### Third Embodiment

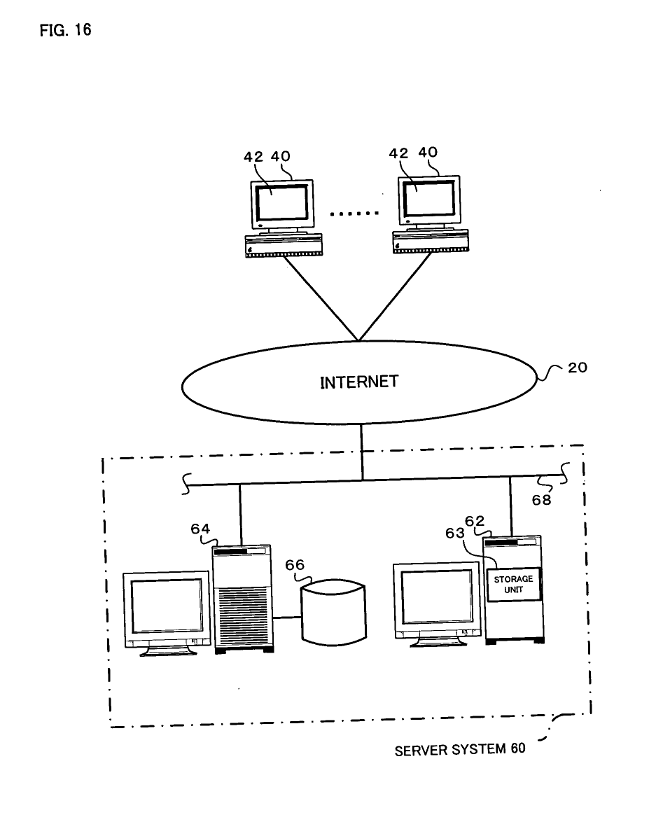

FIG. 16 schematically illustrates the construction of a server system 60 in a third embodiment of the invention. The server system 60 includes a Web server 62 and a database server 64, which are mutually connected in a communicable manner via a network cable 68.

The Web server 62 executes a diversity of programs stored in an internal storage unit 63 and thereby functions as a server to open a used article quotation site that provides a trade-in quote of each used personal computer owned by each user or as a server to open a shopping site that sells new personal computers. The Web server 62 functions to receive a request from each of the user computers 40, make a reply to the request, and transmit the reply to the user computer 40. The Web server 62 also functions to receive information required for quotation (hereafter referred to as quotation requirement information) from each of the user computers 40, transfer the quotation requirement information to the database server 64, activate the database server 64 to compute a trade-in quote, receive a result of the computation, make a reply based on the received computation result, and transfer the reply to the user computer 40. The quotation requirement information represents information on classes and performances of components constituting used personal computers, as discussed in detail later.

Like the data storage device 16 of the first embodiment, a data storage device 66 is connected to the database server 64 and stores a component quote table, in which component names and respective classes of components included in used personal computers are mapped to values (see FIG. 2). The components of the personal computers are grouped by the component names, such as CPUs, memories, HDDs, FDDs CD-ROMs, LAN cards, instruction manuals, and packages. The CPUs are further classified into classes by the name of the processor and the clock frequency, and the values are set for the respective classes. The memories and the HDDs are classified into classes by their capacities, and the values are set for the respective classes. Although not being specifically illustrated, the CD-ROMs are classified into classes by the function (for example, a DVD readable function or a DVD writable function), and the values are set for the respective classes. The values of the FDDs, the LAN cards, the instruction manuals, and the packages do not depend upon their classes but are set according to their presence or absence.

The database server 64 is connected with the data storage device 66. The database server 64 functions to retrieve the data storage device 66, based on the quotation requirement information regarding each used personal computer, which has been received from each of the user computers 40 via the Web server 62, compute a total value of respective used components as a maximum trade-in quote Pmax, and transfer the computed maximum trade-in quote Pmax to the Web server 62.

As discussed in the first embodiment, the user computer 40 is a known general-purpose personal computer used by either an individual or a legal entity. The user computer 40 utilizes a Web browser installed therein to gain access to the used article quotation site or the shopping site opened by the Web server 62 via the Internet 20. The user computer 40 makes various pieces of information shown on the display 42.

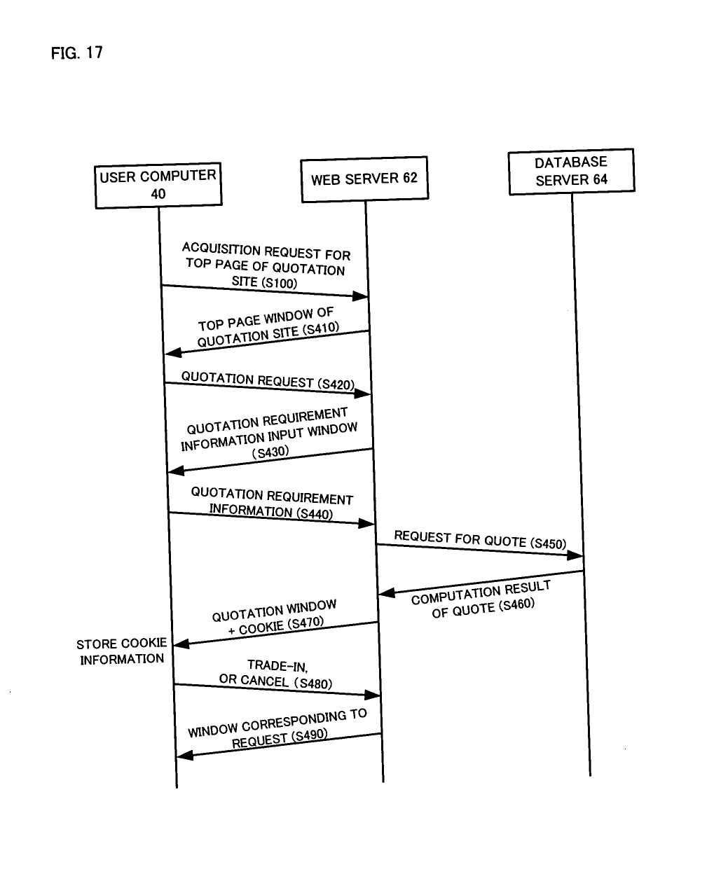

The server system 60 of the third embodiment works as discussed below, when functioning to open the used article quotation site. FIG. 17 shows a time series process of communication between the Web server 62, the database server 64, and the user computer 40.

The user activates the Web browser on the user computer 40 and inputs a URL (Uniform Resource Locator) of the used article quotation site opened by the Web server 62. The user computer 40 then sends an acquisition request for a top page of the used article quotation site to the Web server 62 via the Internet 20 (step S400). The Web server 62 receives the acquisition request and transmits a top page window (not shown) of the used article quotation site to the user computer 40 via the Internet 20 (step S410). The user computer 40 opens the received top page window of the used article quotation site on the display 42.

When the user clicks a trade-in quotation request button provided on the top page window of the used article quotation site, the user computer 40 sends a trade-in quotation request to the Web server 62 via the Internet 20 (step S420). The Web server 62 receives the trade-in quotation request and transmits a quotation requirement information input window to the user computer 40 via the Internet 20 (step S430). The user computer 40 opens the received quotation requirement information input window on the display 42. Here the quotation requirement information is information required for trade-in quotation of each used personal computer and represents information on the respective components of each used personal computer. The quotation requirement information input window of the third embodiment is identical with that of the first embodiment shown in FIG. 4.

The user inputs information on the respective components on quotation requirement information input window and clicks an ‘OK’ button provided on the quotation requirement information input window (see FIG. 4). The user computer 40 then transmits the quotation requirement information to the Web server 62 via the Internet 20 (step S440). The Web server 62 receives the transmitted quotation requirement information and sends the quotation requirement information and a request signal f or trade-in quote to the database server 64 (step S450). The database server 64 receives the request signal for trade-in quote and the quotation requirement information, refers to the component quote table (see FIG. 2) stored in the data storage device 66 based on the quotation requirement Information, and computes the maximum trade-in quote Pmax. The concrete procedure of computation reads the value mapped to the processor name of the CPU and the clock frequency, the value mapped to the capacity of the memory, the value mapped to the capacity of the HDD, and the other additional values from the component quote table shown in FIG. 2 and calculates the total of these values of the components according to Equation 5 given below as the maximum trade-in quote Pmax:

Pmax=Σ(Values of Components) [Equation 5]

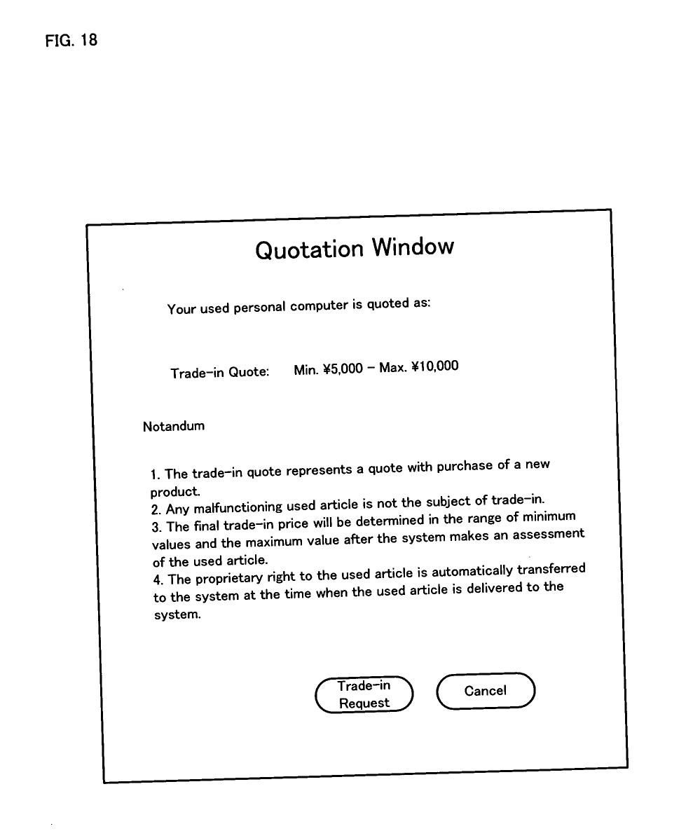

After computation of the maximum trade-in quote Pmax, the database server 64 transmits the computed maximum trade-in quote Pmax to the Web server 62 (step S460). The Web server 62 receives the transmitted maximum trade-in quote Pmax from the database server 64, determines a minimum trade-in quote Pmin, based on the maximum trade-in quote Pmax, creates a quotation window including trade-in description, the minimum trade-in quote Pmin, the maximum trade-in quote Pmax, a Trade-in Request button, and a Cancel button, and sends the quotation window thus created to the user computer 40 (step S470). At this moment, cookie information, which includes the minimum trade-in quote Pmin, the maximum trade-in quote Pmax, and the quotation requirement information received from the user computer 40 at step S440, is attached to the quotation window and is sent together to the user computer 40. The user computer 40 opens the received quotation window on the display 42 and stores the received cookie information into a predetermined storage area in the user computer 40. One example of the quotation window open on the display 42 is shown in FIG. 18. The trade-in description shows that the trade-in quote represents a quote of the used article with purchase of a new product, that any malfunctioning used article is not the subject of trade-in, that the final trade-in price will be determined in the range of a minimum value and a maximum value after the system makes an assessment of the used article, and that the proprietary right to the used article is automatically transferred to the system at the time when the used article is delivered to the system (see ‘Notandum’ in the quotation window of FIG. 18).

The user reads the notandum to recognize the contents of the quotation window and clicks the ‘Trade-in Request’ button to effectuate a trade-in or the ‘Cancel’ button to throw up a trade-in. The user computer 40 respectively sends a trade-in request signal or a cancellation request signal to the Web server 62 via the Internet 20 in response to the click of the ‘Trade-in Request’ button or the ‘Cancel’ button (step S480). The Web server 62 receives either of the trade-in request or the cancellation request signals, analyzes the received request signal, and sends a window corresponding to the analyzed request signal to the user computer 40 (step S490). When the received signal represents the trade-in request, the Web server 62 sends a top page window of a shopping site (not shown) where the user can purchase new products, to the user computer 40. When the received signal represents the cancellation request, on the other hand, the Web server 62 sends the top page window of the used article quotation site to the user computer 40.

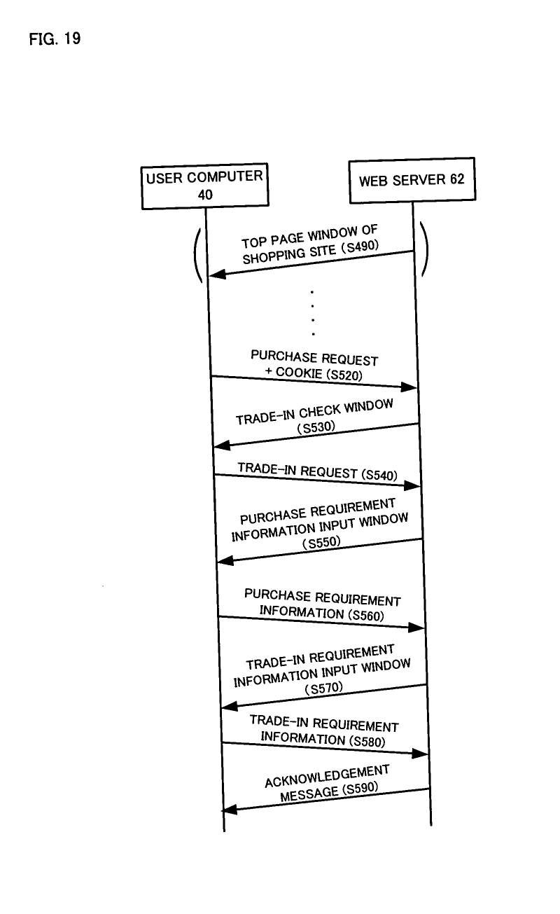

The server system 60 of the third embodiment works as discussed below, when functioning to open the shopping site. FIG. 19 shows a time-series process of communication between the Web server 62 and the user computer 40. It is here assumed that the user refers to the result of the quotation with regard to the used personal computer on the used article quotation site and clicks the ‘Trade-in Request’ button at step S480 and that the top page window of the shopping site is sent to the user computer 40 in response to the click of the ‘Trade-in Request’ button at step S490.

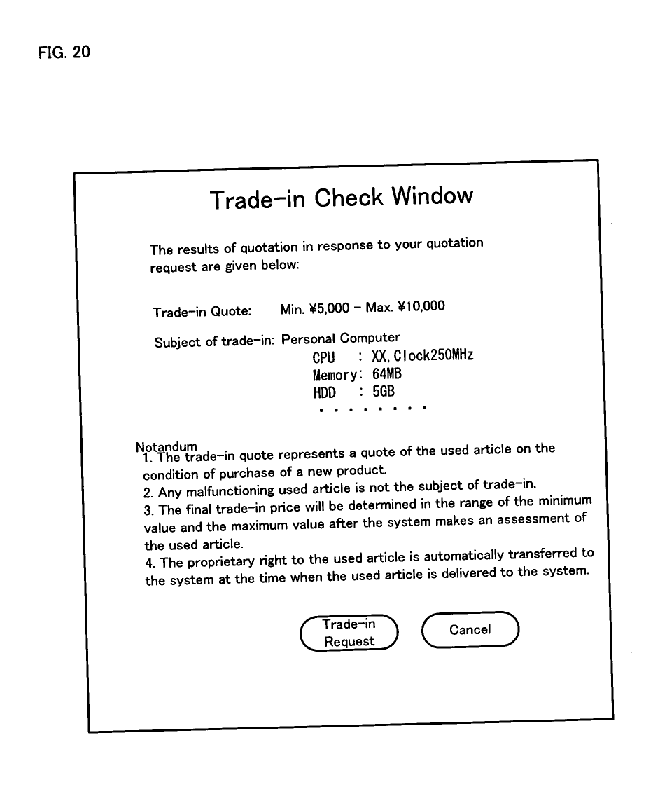

The user selects one or multiple desired products among a diversity of computer products on the top page window of the shopping site and adds all of the selected products to a shopping cart. Transmission of requests and replies is repeated between the user computer 40 and the Web server 62 in this process, although the details of the communication are not discussed specifically. In response to the user's click of a Purchase button (not shown), the user computer 40 sends a purchase request of the products added to the shopping cart to the Web server 62 via the Internet 20 (step S520). Here the user computer 40 attaches the cookie information received from the Web server 62 at step S470 to the purchase request and sends the cookie information together with the purchase request to the Web server 62. The Web server 62 stores the received cookie information into the internal storage unit 63, creates a trade-in check window based on the minimum trade-in quote Pmin, the maximum trade-in quote Pmax, and the quotation requirement information (that is, the information regarding the components of the used personal computer as a subject of trade-in) included in the cookie information, and sends the trade-in check window thus created to the user computer 40 via the Internet 20 (step S530). One example of the trade-in check window is shown in FIG. 20. The trade-in check window includes the minimum trade-in quote Pmin, the maximum trade-in quote Pmax, a subject of trade-in, trade-in description, a ‘Trade-in Request’ button, and a ‘Cancel’ button. The trade-in description in the trade-in check window is identical with the trade-in description included in the quotation window of FIG. 18. Part or all of the quotation requirement information, for example, the processor name and the clock frequency with regard to the CPU and the capacities with regard to the memory and the HDD, is shown in the box of the subject of trade-in.

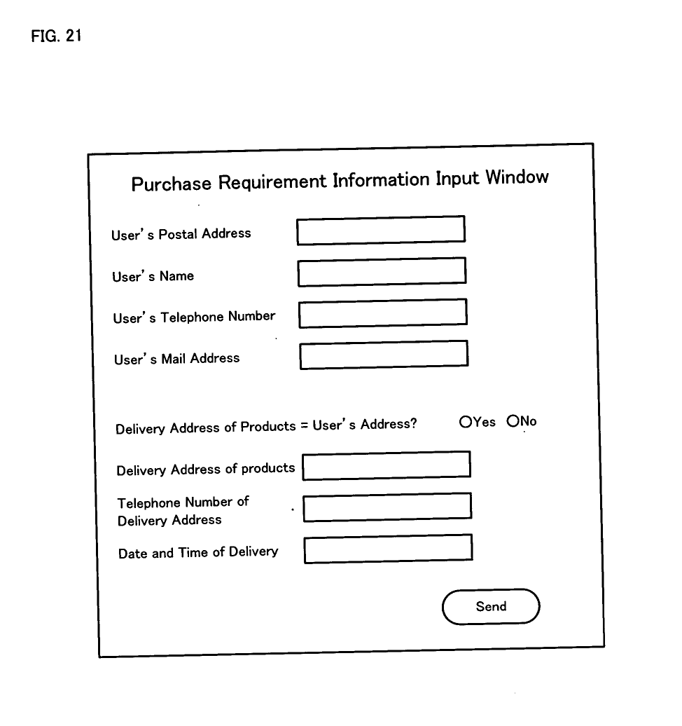

The user reads the contents of the trade-in check window and clicks the ‘Trade-in Request’ button to effectuate a trade-in or the ‘Cancel’ button to throw up a trade-in. The user has already clicked the ‘Trade-in Request’ button on the used article quotation site and, in many cases, is thus expected to click the ‘Trade-in Request’ button again on the trade-in check window of the shopping site. The following description is on the assumption that the user has clicked the ‘Trade-in Request’ button in the trade-in check window. The user computer 40 sends a trade-in request to the Web server 62 via the Internet 20 in response to a click of the ‘Trade-in Request’ button on the trade-in check window (step S540). The Web server 62 receives the trade-in request and sends a purchase requirement information input window to the user computer 40 via the Internet 20 (step S550). The user computer 40 then opens the received purchase requirement information input window on the display 42. One example of the purchase requirement information input window is shown in FIG. 21. Here the purchase requirement information includes the postal address, the name, the telephone number, and the mail address of the user, a delivery address of products where one or multiple products purchased at the shopping site are to be delivered, the telephone number of the delivery address, the date and time of delivery, and the payment policy. In the case where the delivery address of products is identical with the postal address of the user, the user is not required to enter the delivery address of products or the telephone number of the delivery address but is only required to click a radio button ‘Yes’ in an input box ‘Delivery Address of Products=User's Address?’ on the purchase requirement information input window of FIG. 21. The user clicks a ‘Send’ button after entry of the required information on this purchase requirement information input window. The user computer 40 then sends the input purchase requirement information to the Web server 62 via the Internet 20 (step S560).

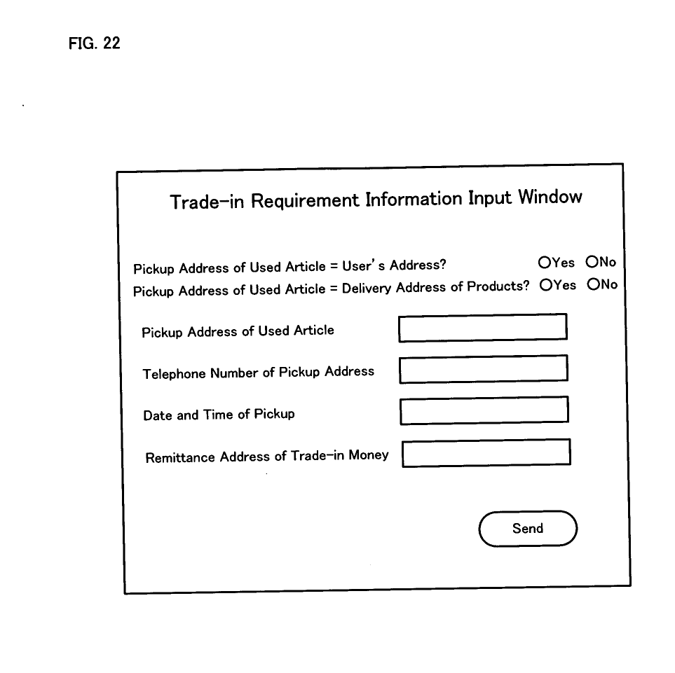

The Web server 62 receives the purchase requirement information and subsequently transmits a trade-in requirement information input window to the user computer 40 via the Internet 20 (step S570). The user computer 40 opens the received trade-in requirement information input window on the display 42. One example of the trade-in requirement information input window is shown in FIG. 22. Here the trade-in requirement information includes a pickup address of the used article, the telephone number of the pickup address, the date and time of pickup, and a remittance address of the trade-in money. In the case where the pickup address of the used article is identical with either of the delivery address of products or the postal address of the user, the user is not required to enter the pickup address of the used article or the telephone number of the pickup address but is only required to click a radio button ‘Yes’ in an input box ‘Pickup Address of Used Article=User's Address?’ or a radio button ‘Yes’ in an input box ‘Pickup Address of Used Article=Delivery Address of Products?’ on the trade-in requirement information input window of FIG. 22. The user clicks a ‘Send’ button after entry of the required information on this trade-in requirement information input window. The user computer 40 then sends the input trade-in requirement information to the Web server 62 via the Internet 20 (step S580). The Web server 62 receives the trade-in requirement information and sends back an acknowledgement message to the user computer 40 (step S590). This terminates the series of processing on the shopping site.

The server system 60 receives a payment for the products, which the user has purchased this time, and delivers the products to the delivery address. When the user requests a trade-in, the server system 60 picks up the used personal computer as a subject of trade-in, makes an assessment, determines the trade-in price in the range of the minimum trade-in quote Pmin to the maximum trade-in quote Pmax according to the assessment result, and sends money of the trade-in price to the user.

The respective constituents of the third embodiment are mapped to the elements of the present invention. The Web server 62 and the database server 64 of the third embodiment correspond to the quotation information transmission module of the invention. The Web server 62 also corresponds to the storage control module and the trade-in procedure execution module of the invention. The quotation window of this embodiment corresponds to the quotation information of the invention.

As described above, the server system 60 of the embodiment does not require the user to enter the same pieces of information many times for trade-in of a used article and thus saves the time and labor of the user. Trade-in of a used personal computer is on the condition of purchase of a new product. The user may thus give a request for trade-in quotation of the used article after completion of the purchase procedure of a new product. When the user has given a request for trade-in quotation of the used article prior to the purchase procedure of a new product, the system of the third embodiment utilizes the trade-in quote and the quotation requirement information at the time of the previous request and thereby desirably saves the user's labor and time of entering the request for trade-in quotation of the used article and the quotation requirement information again.

When the user has given a request for trade-in quotation prior to the purchase procedure, the Web server 62 can obtain the trade-in quote and the quotation requirement information by simply reading the cookie information stored in the user computer 40. This advantageously relieves the process load of the system.

The trade-in quote is set, based on the information regarding the components included in each used article. The trade-in value of each used article is thus determined according to its components. The quote of the used article is provided in the range of a minimum quote to a maximum quote. The user is thus informed of the minimum trade-in value of the used article and of the possible trade-in at the maximum value according to the conditions of the used article. The user gives a request for a trade-in or gives up the trade-in, based on the minimum value and the maximum value.

The third embodiment discussed above is only illustrative and not restrictive in any sense. There may be many modifications, changes, and alterations of the third embodiment.

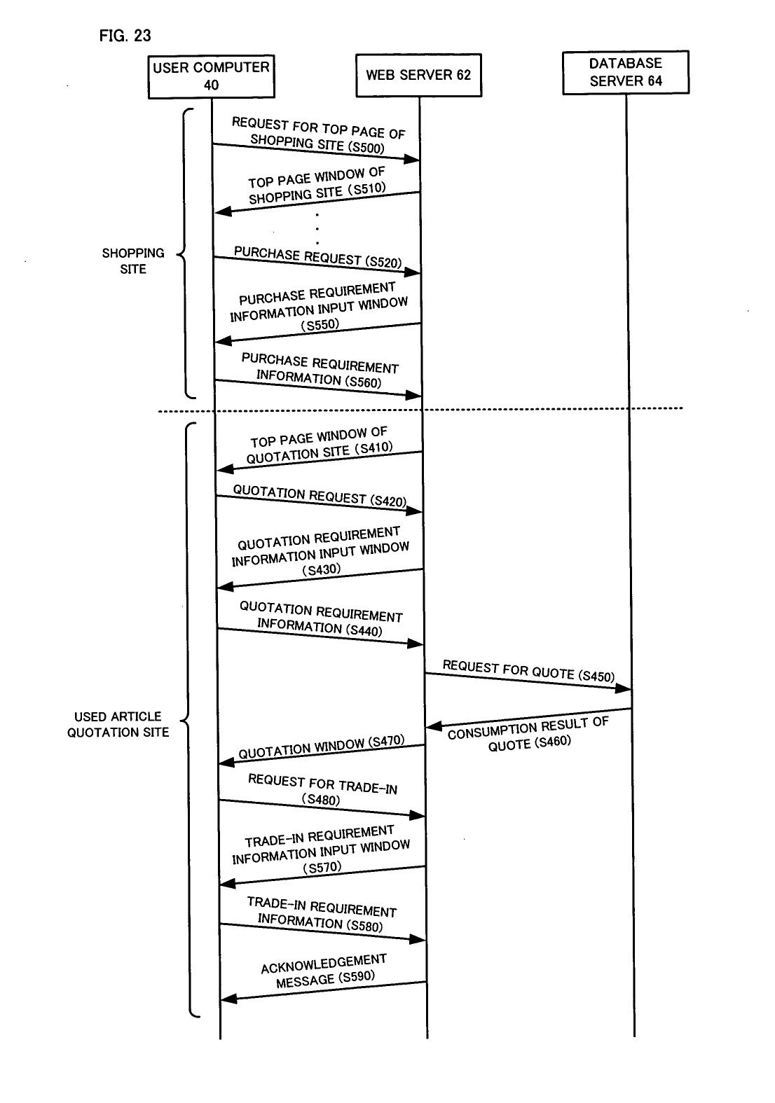

The server system 60 of the third embodiment receives the information relating to the trade-in quotation of the used article from the user computer 40 at the used article quotation site and subsequently receives the information relating to the purchase procedure of products from the user computer 40 at the shopping site. On the contrary, the server system 60 may receive the information relating to the purchase procedure of products from the user computer 40 at the shopping site and subsequently require the user computer 40 to enter the information relating to the trade-in quotation of the used article at the used article quotation site. The series of processing in this situation is shown in the process chart of FIG. 23. In the time-series process of FIG. 23, when the user enters the URL of a shopping site on the Web browser, the user computer 40 sends an acquisition request for a top page of the shopping site to the Web server 62 via the Internet 20 (step S500). The Web server 62 receives the acquisition request and sends a top page window of the shopping site to the user computer 40 via the Internet 20 (step S510). The user computer 40 opens the received top page window of the shopping site on the display 42. When the user adds one or multiple desired products for purchase to a shopping cart and clicks a purchase button (not shown), the user computer 40 sends a purchase request (without cookie) of the products added to the shopping cart to the Web server 62 via the Internet 20 (step S520). The Web server 62 receives the purchase request and sends the purchase requirement information input window to the user computer 40 via the Internet 20 (step S550). The user computer 40 sends the entries of purchase requirement information to the Web server 62 (step S560). This series of processing is identical with the processing of the third embodiment and is thus not described in detail. After this series of processing at the shopping site, the Web server 62 executes a series of processing at the used article quotation site. The processing of steps S410 through S480 is identical with the processing of the third embodiment and is thus not specifically described here. In this modified arrangement, however, no cookie information is attached to the quotation window at step S470 and the Web server 62 receives a trade-in request at step S480. The Web server 62 sends the trade-in requirement information input window to the user computer 40 (step S570), receives the entries of trade-in requirement information from the user computer 40 (step S580), and sends an acknowledgement message to the user computer 40 (step S590). This series of processing is also identical with the processing of the third embodiment and is thus not described in detail. In this modified arrangement, in the case where the pickup address of the used article is identical with either of the delivery address of products or the postal address of the user, the user is not required to enter the pickup address of the used article or the telephone number of the pickup address but is only required to click a radio button ‘Yes’ in an input box ‘Pickup Address of Used Article =User's Address?’ or a radio button ‘Yes’ in an input box ‘Pickup Address of Used Article=Delivery Address of Products?’ on the trade-in requirement information input window of FIG. 22. The pickup address of the used article and the telephone number of the pickup address are included in the information relating to the request for trade-in quotation, whereas the user's address and the delivery address of products are included in the information relating to the purchase procedure of products. The user is not required to re-enter the overlapping pieces of information. This arrangement does not require the user to enter the same pieces of information for trade-in of a used article many times and thus saves the labor and the time of the user.

In the server system 60 of the third embodiment, the Web server 62 sends the cookie information, which includes the minimum trade-in quote Pmin, the maximum trade-in quote Pmax, and the quotation requirement information received from the user computer 40, to the user computer 40. This procedure may be modified as discussed below. According to the modified procedure, the Web server 62 allocates a quotation ID to the trade-in quotes and the quotation requirement information, creates a quotation window including the quotation ID, the trade-in quotes, and the quotation requirement information, and stores the created quotation window with the quotation ID into the internal storage unit 63 of the Web server 62. A window opening in response to the purchase request at the shopping site has a quotation ID input box. When the user has obtained the trade-in quote at the used article quotation site before moving into the shopping site, the user enters the given quotation ID in the quotation ID input box and then gives a purchase request for products. The user computer 40 sends the purchase request and the quotation ID to the Web server 62 via the Internet 20. The Web server 62 retrieves the storage unit 63, reads the trade-in quote and the quotation requirement information corresponding to the received quotation ID, and creates the trade-in check window (see FIG. 20). This arrangement also ensures the similar functions and effects to those of the third embodiment. The trade-in quote and the quotation requirement information are stored in the internal storage unit 63 of the Web server 62. This facilitates the information management of the Web server 62.

The procedure of the third embodiment reads the values of the components included in each used personal computer from the component quote table and specifies the total of the values of the components as the maximum trade-in quote Pmax. One modification may specify the total of the values of the components as the minimum trade-in quote Pmin and determine the maximum trade-in quote Pmax based on the minimum trade-in quote Pmin. Another modification may prepare a component quote table including both a minimum trade-in price and a maximum trade-in price corresponding to each component and compute both the total of the maximum values of the components as the maximum trade-in quote Pmax and the total of the minimum values of the components as the minimum trade-in quote Pmin. The procedure of the third embodiment gives the range of the minimum trade-in quote Pmin and the maximum trade-in quote Pmax. One possible modification may not set any width to the trade-in quote but give a fixed value as the trade-in quote.

The third embodiment regards the used personal computers. The technique of the invention is also applicable to a diversity of other used articles, for example, used peripheral equipment of personal computers like displays, printers, and scanners, used office automation equipment like photocopiers, facsimiles, and paper shredders, used home electric appliances like television sets, refrigerators, washing machines, and microwave ovens, used vehicles like automobiles, motorbikes, bicycles, and boats, used sports equipment including golf clubs, tennis rackets, skies, and snowboards, and existing homes like apartments and houses.

In the structure of the third embodiment discussed above, the server system 60 includes two servers, the Web server 62 and the database server 64. The server system may have only one server, where the Web server 62 has the functions of both the database server 64 and the Web server 62. The server system may otherwise include three or more servers. The server system opening the used article quotation site may be separate from the server system opening the shopping site. These two server systems may be constructed as the server system of the invention.

What is claimed is:

1. A used article quotation method that provides a user computer with a quote for acceptance of a used article from a user, said used article quotation method comprising the steps of:
(a) causing a server computer, which is connected with the user computer in a communicable manner, to receive a quotation request of the used article and quotation requirement information, which is required for quotation of the used article, from the user computer and to determine a trade-in quote for the acceptance of the used article that is a trade-in of the used article with purchase of a product and a cash-out quote for the acceptance of the used article that is a cash-out of the used article without purchase of a product, based on the quotation requirement information; and
(b) causing the server computer to send quotation information, which includes the trade-in quote and the cash-out quote determined in said step (a), to the user computer.

2. A used article quotation method in accordance with claim 1, wherein said step (a) causes the server computer to determine the trade-in quote and the cash-out quote in such a manner that the trade-in quote is advantageous over the cash-out quote.

3. A used article quotation method in accordance with claim 1, wherein said step (a) causes the server computer either to determine first the cash-out quote and then the trade-in quote based on the predetermined cash-out quote in such a manner that the trade-in quote is advantageous over the cash-out quote, or to determine first the trade-in quote and then the cash-out quote based on the predetermined trade-in quote in such a manner that the trade-in quote is advantageous over the cash-out quote.

4. A used article quotation method in accordance with claim 3, wherein said step (a) causes the server computer either to determine the cash-out quote and compute the trade-in quote as a function of the predetermined cash-out quote, or to determine the trade-in quote and compute the cash-out quote as a function of the predetermined trade-in quote.

5. A used article quotation method in accordance with claim 1, wherein said step (a) causes the server computer to set a minimum value and a maximum value of the cash-out quote and a maximum value and a minimum value of the trade-in quote.

6. A used article quotation method in accordance with claim 1, wherein said step (b) causes the server computer to send a quotation window, which includes a cash-out option selected by the user to request a cash-out at the cash-out quote and a trade-in option selected by the user to request a trade-in at the trade-in quote, in addition to the cash-out quote and the trade-in quote, as the quotation information to the user computer.

7. A used article quotation method in accordance with claim 6, said used article quotation method further comprising the steps of:
(c) in response to receipt of the user's selection of the trade-in option from the user computer after said step (b), causing the server computer to store a trade-in specification, which includes the quotation requirement information and the trade-in quote, into a storage unit; and
(d) in response to receipt of a product purchase request from the user computer, causing the server computer to read the trade-in specification stored in said storage unit, to send the read-out trade-in specification to the user computer, and to ask the user whether to effectuate a trade-in according to the trade-in specification.

8. A used article quotation method in accordance with claim 1, wherein said step (b) causes the server computer to determine whether the cash-out quote, which has been determined based on the quotation requirement information, is in a preset allowable cash-out value range and, when it is determined that the cash-out quote is out of the preset allowable cash-out value range, to send the quotation information excluding the cash-out quote to the user computer.

9. A used article quotation method in accordance with claim 1, wherein said step (b) causes the server computer to send a quotation window, which includes a cash-out option selected by the user to request a cash-out at the cash-out quote and a trade-in option selected by the user to request a trade-in at the trade-in quote, in addition to the cash-out quote and the trade-in quote, as the quotation information to the user computer and, when the cash-out quote, which has been determined based on the quotation requirement information, is out of a preset allowable cash-out value range, to send either of the quotation window excluding the cash-out option or the quotation window including the cash-out option in a certain state that does not allow for the user's selection, to the user computer.

10. A used article quotation method in accordance with claim 1, wherein said step (a) causes the server computer to receive the quotation request of the used article and information regarding a component included in the used article as the quotation requirement information, which is required for quotation of the used article, from the user computer and to determine the trade-in quote and the cash-out quote, based on the information regarding the component included in the used article.

11. A used article quotation system that provides a user computer with a quote for acceptance of a used article from a user, said used article quotation system comprising:
a quote determination module that receives a quotation request of the used article and quotation requirement information, which is required for quotation of the used article, from the user computer and determines a trade-in quote for the acceptance of the used article that is a trade-in of the used article with purchase of a product and a cash-out quote for the acceptance of the used article that is a cash-out of the used article without purchase of a product, based on the quotation requirement information; and
a quotation information transmission module that sends quotation information, which includes the trade-in quote and the cash-out quote determined by said quote determination module, to the user computer.

12. A used article quotation method that provides a user computer with a quote for acceptance of a used article from a user, said used article quotation method comprising the steps of:
(a) causing a server computer, which is connected with the user computer in a communicable manner, to receive a quotation request of the used article and quotation requirement information, which is required for quotation of the used article, from the user computer and to set a tentative quote of the used article, based on the quotation requirement information;
(b) causing the server computer to determine whether assessment of the used article is required, according to the tentative quote;
(c) when it is determined in said step (b) that assessment of the used article is not required, causing the server computer to determine a settled price of no value range according to the tentative quote as a firm price for acceptance of the used article without assessment and to set the firm price to a final quote of the used article; and
(d) causing the server computer to send quotation information including the final quote, to the user computer.

13. A used article quotation method in accordance with claim 12, wherein said step (b) causes the server computer to determine that assessment of the used article is not required, when the tentative quote is less than a preset assessment requirement judgment value.

14. A used article quotation method in accordance with claim 12, wherein said step (c), when it is determined in said step (b) that assessment of the used article is not required, causes the server computer to specify a value level of the tentative quote and to set either of the settled price of no value range determined according to the tentative quote or a fixed value regardless of the tentative quote to the firm price, based on the specified value level.

15. A used article quotation method in accordance with claim 12, wherein said step (c), when it is determined in said step (b) that assessment of the used article is not required, causes the server computer to compare the tentative quote with a predetermined value level criterion and to set the settled price of no value range determined according to the tentative quote to the firm price in the case where the tentative quote exceeds the predetermined value level criterion and to set a fixed value regardless of the tentative quote to the firm price in the case where the tentative quote is not greater than the predetermined value level criterion.

16. A used article quotation method in accordance with claim 12, wherein said step (c), when it is determined in said step (b) that assessment of the used article is required, causes the server computer to set a value range according to the tentative quote to the final quote of the used article on the condition of assessment of the used article.

17. A used article quotation method in accordance with claim 12, said used article quotation method further comprising the step of:
(e) causing the server computer to determine whether the used article is worth of acceptance, based on the setting of the tentative quote in said step (a),
wherein, when it is determined in said step (e) that the used article is not worth of acceptance, said step (d) causes the server computer to send the quotation information including a notice that the used article is not acceptable, to the user computer.

18. A used article quotation method in accordance with claim 12, wherein said step (a) causes the server computer to receive the quotation request of the used article and the quotation requirement information, which is required for quotation of the used article, from the user computer and to set a tentative trade-in quote for the acceptance of the used article that is a trade-in with purchase of a product and a tentative cash-out quote for the acceptance of the used article that is a cash-out without purchase of a product, based on the quotation requirement information,
said step (b) causes the server computer to determine whether assessment of the used article is required individually with regard to the trade-in and the cash-out,
when it is determined in said step (b) that assessment of the used article is not required with regard to each of the trade-in and the cash-out, said step (c) causes the server computer to determine a settled trade-in price of no value range according to the tentative trade-in quote as a firm trade-in price for the trade-in without assessment and set the firm trade-in price to a final trade-in quote of the used article, and to determine a settled cash-out price of no value range according to the tentative cash-out quote as a firm cash-out price for the cash-out without assessment and set the firm cash-out price to a final cash-out quote of the used article, and
said step (d) causes the server computer to send the quotation information including both the final trade-in quote and the final cash-out quote, to the user computer.

19. A used article quotation method in accordance with claim 18, said used article quotation method further comprising the step of:
(f) causing the server computer to determine whether the used article is worth of acceptance with regard to at least the cash-out, based on the setting of the tentative cash-out quote in said step (a),
wherein, when it is determined in said step (f) that the used article is not worth of acceptance, said step (d) causes the server computer to send the quotation information including a notice that the used article is not acceptable, to the user computer.

20. A used article quotation system that provides a user computer with a quote for acceptance of a used article from a user, said used article quotation system comprising:
a tentative quote setting module that receives a quotation request of the used article and quotation requirement information, which is required for quotation of the used article, from the user computer and sets a tentative quote of the used article based on the quotation requirement information;
an assessment requirement judgment module that determines whether assessment of the used article is required, according to the tentative quote set by said tentative quote setting module;
a final quote setting module that, when it is determined that assessment of the used article is not required by said assessment requirement judgment module, determines a settled price of no value range according to the tentative quote as a firm price for acceptance of the used article without assessment and sets the firm price to a final quote of the used article; and
a quotation information transmission module that sends quotation information including the final quote set by said final quote setting module, to the user computer.

21. A server management method for managing a server, which is connected with a user computer in a communicable manner and opens a used article quotation site that is utilized by a user to ask for acceptance of a used article and a shopping site that is utilized by the user to purchase a product, said server management method comprising the step of:
when a server computer receives information regarding a product purchase procedure at the shopping site from the user computer after receipt of information regarding a trade-in quotation request of the used article at the used article quotation site from the user computer, causing the server computer to go through a trade-in procedure without requiring the user computer to reenter the information regarding the trade-in quotation request of the used article.

22. A server management method for managing a server, which is connected with a user computer in a communicable manner and opens a used article quotation site that is utilized by a user to ask for acceptance of a used article and a shopping site that is utilized by the user to purchase a product, said server management method comprising the step of:
when a server computer requires the user computer to enter information regarding a trade-in quotation request of the used article at the used article quotation site after receipt of information regarding a product purchase procedure at the shopping site from the user computer, causing the server computer not to require the user computer to reenter a piece of information overlapping with the information regarding the product purchase procedure, among pieces of the information regarding the trade-in quotation request of the used article.

23. A used article quotation method that is utilized for a trade-in of a used article from a user, said used article quotation method comprising the steps of:
(a) causing a server computer, which is connected with the user computer in a communicable manner, to receive information regarding a trade-in quotation request of the used article from a user computer, to determine a trade-in quote of the used article based on the information regarding the trade-in quotation request, and to send quotation information including the trade-in quote of the used article, to the user computer;
(b) causing the server computer to send to the user computer either of the information regarding the trade-in quotation request of the used article or the trade-in quote of the used article in a specific format that allows for storage in the user computer; and
(c) in the case where either of the information regarding the trade-in quotation request of the used article or the trade-in quote of the used article has been stored in the user computer, causing the server computer to make a trade-in procedure of the used article without requiring the user computer to reenter the information regarding the trade-in quotation request of the used article, after the user completes a product purchase procedure.

24. A used article quotation method in accordance with claim 23, wherein said step (b) causes the server computer to send to the user computer either of the information regarding the trade-in quotation request of the used article or the trade-in quote of the used article as a cookie that is storable in the user computer.

25. A used article quotation method in accordance with claim 23, wherein said step (b) causes the server computer to store either of the information regarding the trade-in quotation request of the used article or the trade-in quote of the used article into a predetermined storage unit, instead of sending to the user computer either of the information regarding the trade-in quotation request of the used article or the trade-in quote of the used article in the specific format that allows for storage in the user computer, and
in the case where either of the information regarding the trade-in quotation request of the used article or the trade-in quote of the used article has been stored in the predetermined storage unit, said step (c) causes the server computer to make the trade-in procedure of the used article without requiring the user computer to reenter the information regarding the trade-in quotation request of the used article, after the user completes the product purchase procedure.

26. A used article quotation method in accordance with claim 23, wherein said step (a) causes the server computer to receive information regarding a component included in the used article as the information regarding the trade-in quotation request from the user computer and to determine the trade-in quote, based on the information regarding the component included in the used article.

27. A used article quotation method in accordance with claim 23, wherein said step (a) causes the server computer to set a minimum value and a maximum value of the trade-in quote of the used article.

28. A server system that is connected with a user computer in a communicable manner and opens a used article quotation site that is utilized by a user to ask for acceptance of a used article and a shopping site that is utilized by the user to purchase a product,
when receiving information regarding a product purchase procedure at the shopping site from the user computer after receipt of information regarding a trade-in quotation request of the used article at the used article quotation site from the user computer, said server system going through a trade-in procedure without requiring the user computer to reenter the information regarding the trade-in quotation request of the used article.

29. A server system that is connected with a user computer in a communicable manner and opens a used article quotation site that is utilized by a user to ask for acceptance of a used article and a shopping site that is utilized by the user to purchase a product,
when requiring the user computer to enter information regarding a trade-in quotation request of the user article at the used article quotation site after receipt of information regarding a product purchase procedure at the shopping site from the user computer, said server system not requiring the user computer to reenter a piece of information overlapping with the information regarding the product purchase procedure, among pieces of the information regarding the trade-in quotation request.

30. A used article quotation system that is connected with a user computer in a communicable manner and utilized by a user to ask for acceptance of a used article, said used article quotation system comprising:
a quotation information transmission module that receives information regarding a trade-in quotation request of the used article from the user computer, determines a trade-in quote of the used article based on the information regarding the trade-in quotation request, and sends quotation information including the trade-in quote of the used article, to the user computer;
a storage control module that sends to the user computer either of the information regarding the trade-in quotation request of the used article or the trade-in quote of the used article in a specific format that allows for storage in the user computer; and
a trade-in procedure execution module that, in the case where either of the information regarding the trade-in quotation request of the used article or the trade-in quote of the used article has been stored in the user computer, makes a trade-in procedure of the used article without requiring the user computer to reenter the information regarding the trade-in quotation request of the used article, after the user completes a product purchase procedure.
